(19) United States
(12) Patent Application Publication
(10) Pub. No.: US 2025/0023780 A1
(43) Pub. Date: Jan. 16, 2025

(54) METHODS AND SYSTEMS THAT AUTOMATICALLY BIND ATTRIBUTE VALUES TO RESOURCE IDENTIFIERS

(71) Applicant: VMware LLC, Palo Alto, CA (US)

(72) Inventors: PRIYANK AGARWAL, Bangalore (IN); Praveen Kumar, Bangalore (IN); Nitin Ramachandra, Bangalore (IN); Aakash Das, Bangalore (IN); Vivek Kumar, Bangalore (IN)

(21) Appl. No.: 18/381,663

(22) Filed: Oct. 19, 2023

Related U.S. Application Data
(63) Continuation-in-part of application No. 18/380,661, filed on Oct. 17, 2023.

(30) Foreign Application Priority Data
Jul. 12, 2023 (IN) 202341046773
Aug. 4, 2023 (IN) 202343052631

(51) Int. Cl. H04L 41/084; H04L 41/08; H04L 41/0806

(52) U.S. Cl. CPC H04L 41/0843

(57) ABSTRACT

The current document is directed to methods and systems that automatically bind an attribute value, within a resource descriptor in a cloud-infrastructure-specification-and-configuration file, that references a parent resource descriptor via a resource identifier to the resource identifier in the parent resource descriptor. One implementation of attribute-value binding is employed in an infrastructure-as-code (“IaC”) cloud-infrastructure-management service or system that automatically generates parameterized cloud templates that represent already deployed cloud-based infrastructure, including virtual networks, virtual machines, load balancers, and connection topologies. The IaC cloud-infrastructure manager provides an infrastructure-discovery service that accesses a cloud-computing facility to obtain information about already deployed cloud infrastructure and that generates a textual description of the deployed infrastructure, which the IaC cloud-infrastructure-manager then transforms into a set of parameterized cloud-infrastructure-specification-and-configuration files, a resource_ids file, and a parameters file that together comprise a parameterized cloud template.

### CROSS-REFERENCE TO RELATED APPLICATION

This application is a Continuation-in-part of patent application Ser. No. 18/380,661 entitled “METHODS AND SYSTEMS THAT AUTOMATICALLY GENERATE PARAMETERIZED CLOUD-INFRASTRUCTURE TEMPLATES”, filed on Oct. 17, 2023, which claims the benefit under 35 U.S.C. 119 (a)-(d) to Foreign application No. 202341046773 filed in India entitled “METHODS AND SYSTEMS THAT AUTOMATICALLY GENERATE PARAMETERIZED CLOUD-INFRASTRUCTURE TEMPLATES”, on Jul. 12, 2023 and Indian application No. 202343052631 entitled “METHODS AND SYSTEMS THAT AUTOMATICALLY BIND ATTRIBUTE VALUES TO RESOURCE IDENTIFIERS” filed on Aug. 4, 2023, by VMware, Inc., which is herein incorporated in its entirety by reference for all purposes.

### TECHNICAL FIELD

The current document is directed to distributed-computer-systems and, in particular, to methods and systems that automatically bind an attribute value, within a resource descriptor in a cloud-infrastructure-specification-and-configuration file, that references a parent resource descriptor via a resource identifier to the resource identifier in the parent resource descriptor.

### BACKGROUND

During the past seven decades, electronic computing has evolved from primitive, vacuum-tube-based computer systems, initially developed during the 1940s, to modern electronic computing systems, including distributed cloud-computing systems, in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including distributed service-oriented applications. Distributed applications, including distributed service-oriented applications and distributed microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated and semi-automated management and administration subsystems impractical, from a time and cost standpoint. Therefore, designers and developers of distributed computer systems and applications continue to seek new approaches to implementing automated and semi-automated management-and-administration facilities and functionalities.

### SUMMARY

The current document is directed to methods and systems that automatically bind an attribute value, within a resource descriptor in a cloud-infrastructure-specification-and-configuration file, that references a parent resource descriptor via a resource identifier to the resource identifier in the parent resource descriptor. One implementation of attribute-value binding is employed in an infrastructure-as-code (“IaC”) cloud-infrastructure-management service or system that automatically generates parameterized cloud templates that represent already deployed cloud-based infrastructure, including virtual networks, virtual machines, load balancers, and connection topologies. The IaC cloud-infrastructure manager provides an infrastructure-discovery service that accesses a cloud-computing facility to obtain information about already deployed cloud infrastructure and that generates a textual description of the deployed infrastructure, which the IaC cloud-infrastructure-manager then transforms into a set of parameterized cloud-infrastructure-specification-and-configuration files, a resource_ids file, and a parameters file that together comprise a parameterized cloud template.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates a number of different cloud-computing facilities that provide computational infrastructure to an organization for supporting the organization's distributed applications and services.

FIG. 9 illustrates a universal-management-interface provided by the currently discussed IaC cloud-infrastructure-management service.

FIG. 10 illustrates the architecture of the currently discussed IaC cloud-infrastructure-management service.

FIG. 11 illustrates the cloud-management interface provided by the currently discussed IaC cloud-infrastructure-management service.

FIG. 12 illustrates components of a GraphQL API interface.

FIGS. 13A-14E illustrate an example schema, an extension to that example schema, and queries, a mutation, and a subscription to illustrate the GraphQL data query language.

FIG. 15 illustrates a stitching process.

FIGS. 16A-D illustrate the YAML Ain′t Markup Language (“YAML”) data serialization language.

FIG. 17 illustrates certain features provided by the Jinja template engine that are used, in addition to YAML, for representing infrastructure in SLS documents.

FIGS. 18A-C illustrate a structured labor state (“SLS”) data file and credential file as well as the output from an Idem describe command.

FIG. 19 illustrates a fundamental control loop involving the Idem service.

FIG. 20 illustrates one implementation of the Idem service.

FIG. 21 illustrates the currently discussed methods and systems that generate parameterized cloud templates corresponding to already deployed and configured cloud infrastructure.

FIG. 22 illustrates a first step in the onboarding process introduced in the preceding paragraph.

FIGS. 23A-B illustrate the concept of pointers to property and tag values in the in-memory data structure discussed above with reference to FIG. 22 and in an parameterized cloud template.

FIG. 24 illustrates a second step and a third step of the onboarding process that follow the first step, discussed above with reference to FIG. 22, in which raw SLS data is loaded into the in-memory data structure 2402.

FIG. 25 illustrates a fourth step in the onboarding process.

FIGS. 26A-E illustrate various types of attribute values.

FIG. 27 illustrates fifth and six steps of the onboarding process.

FIGS. 28A-E

FIGS. 29A-F

FIGS. 30A-B

FIGS. 31A-J

### DETAILED DESCRIPTION

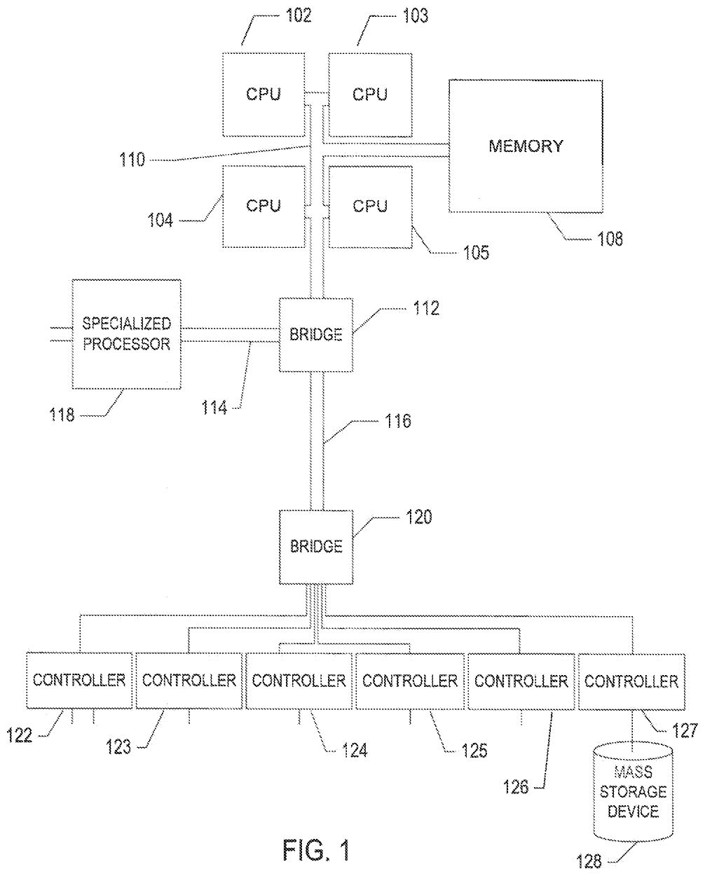

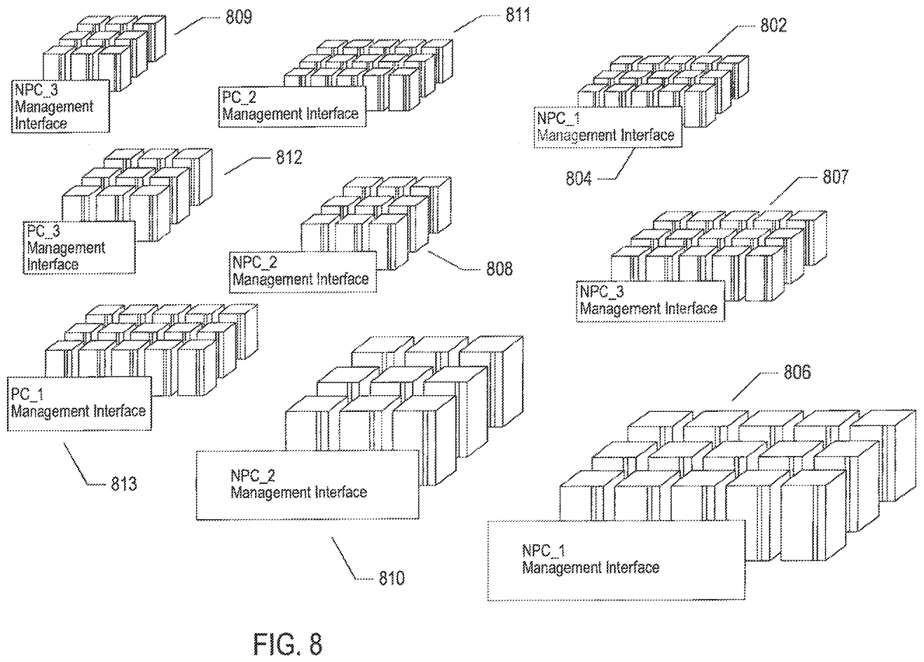

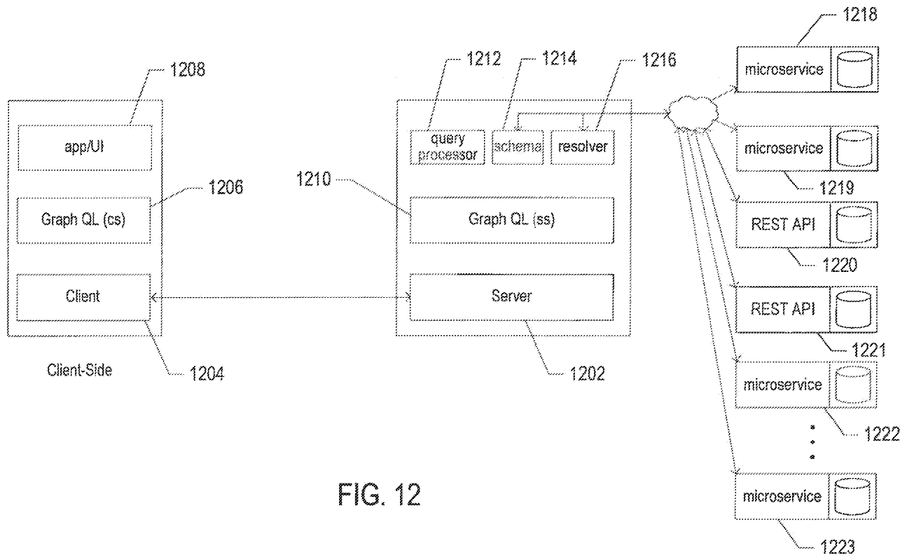

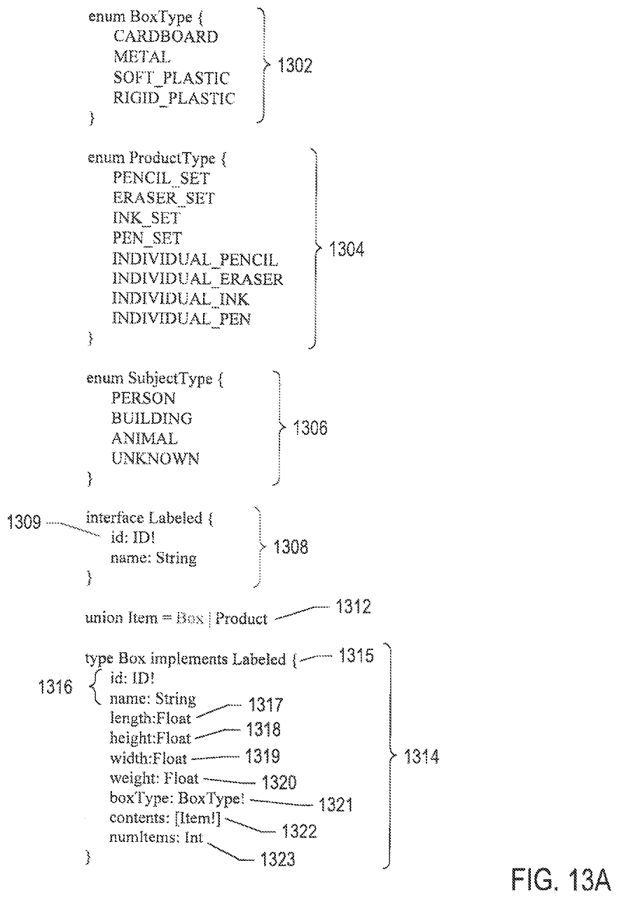

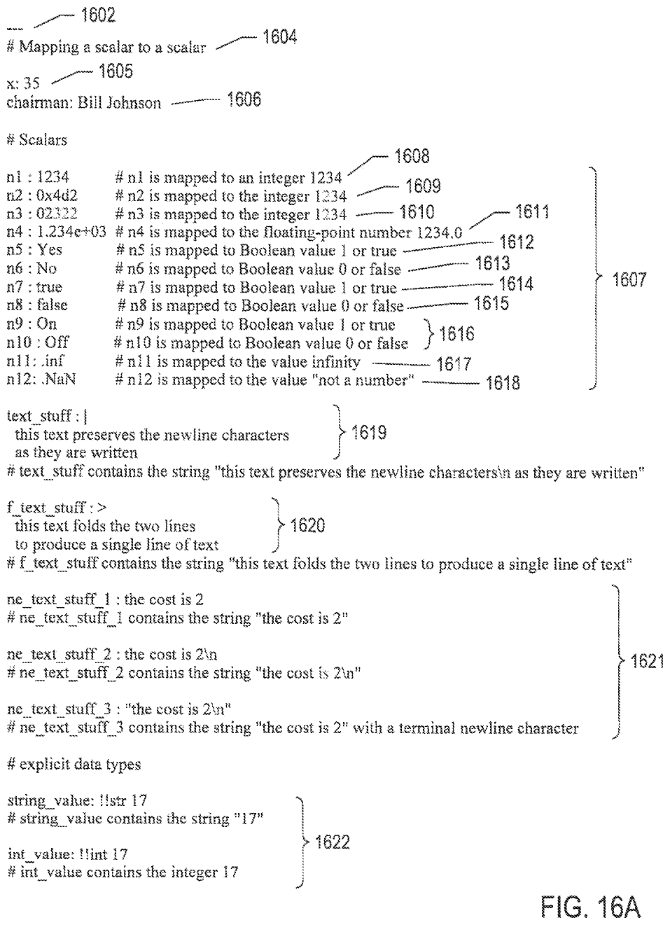

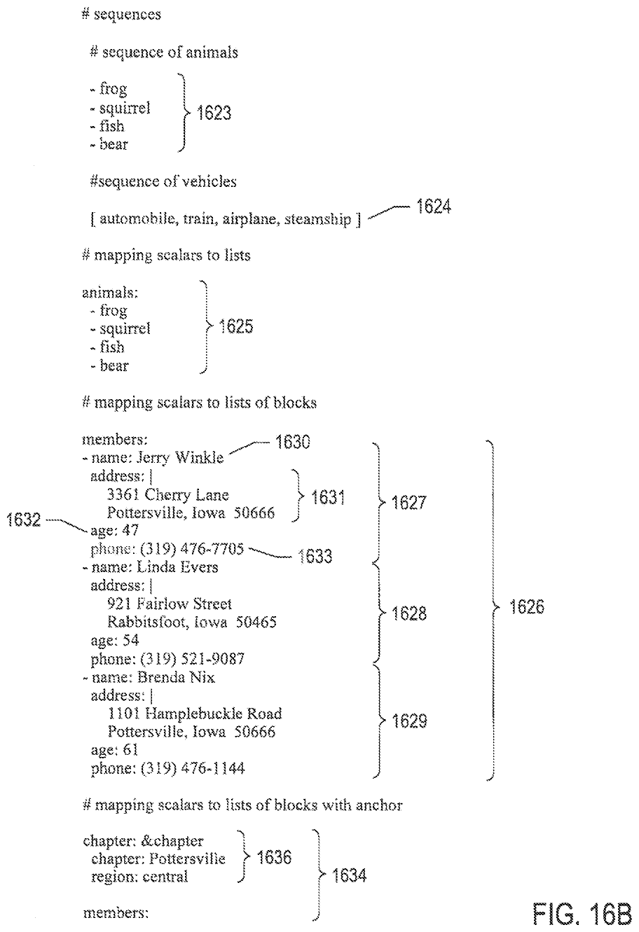

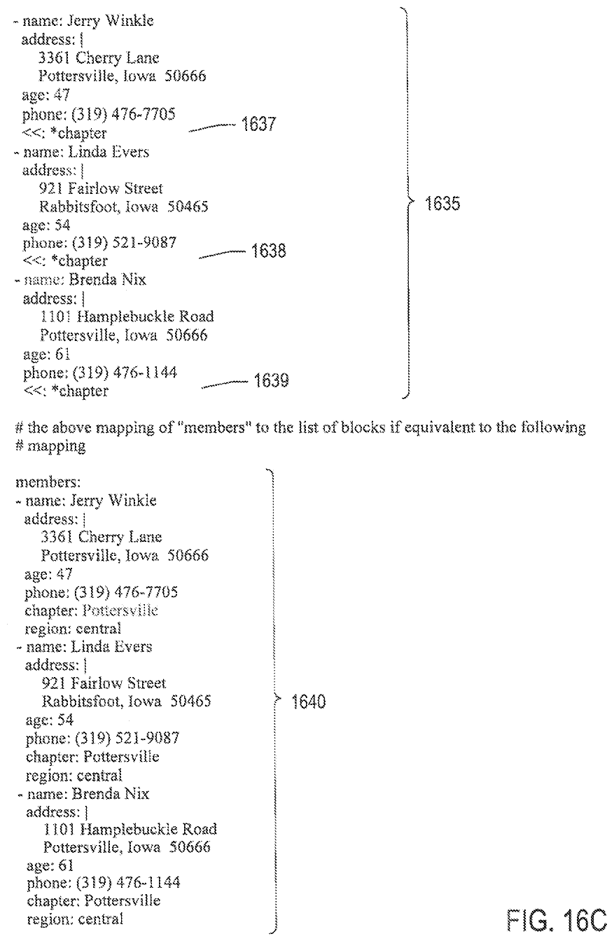

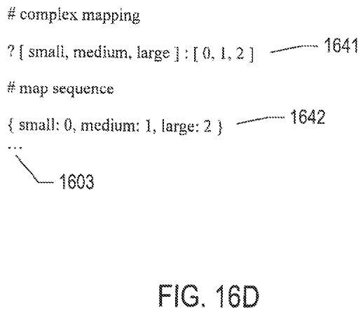

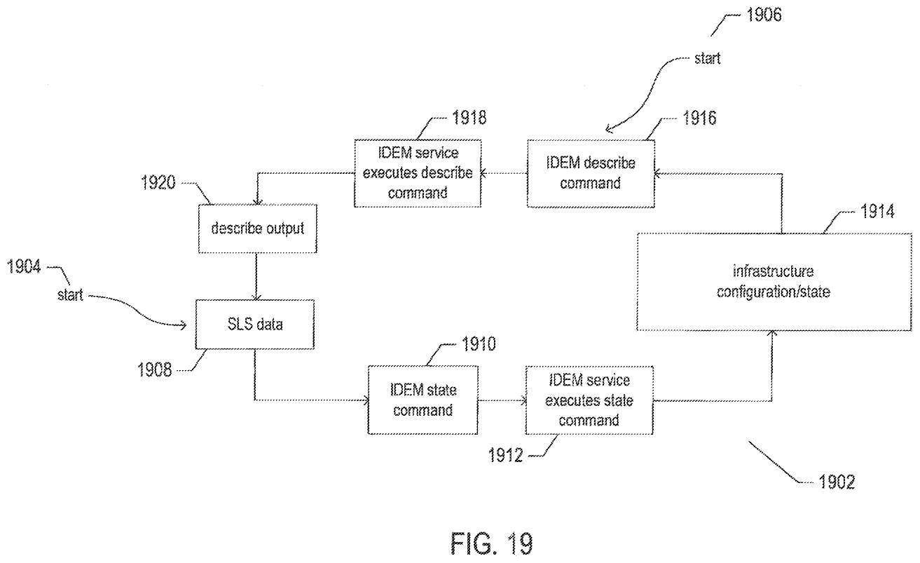

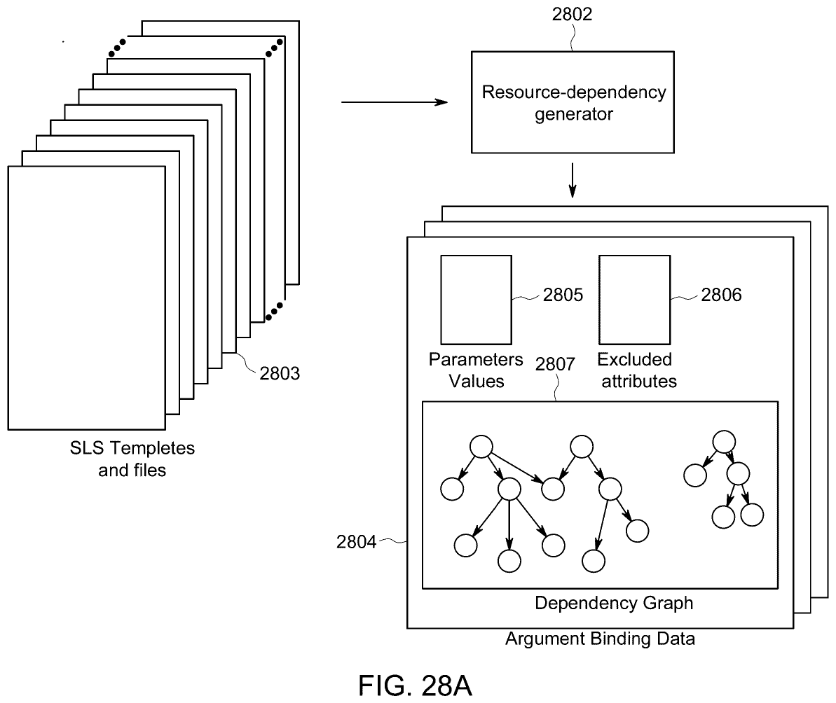

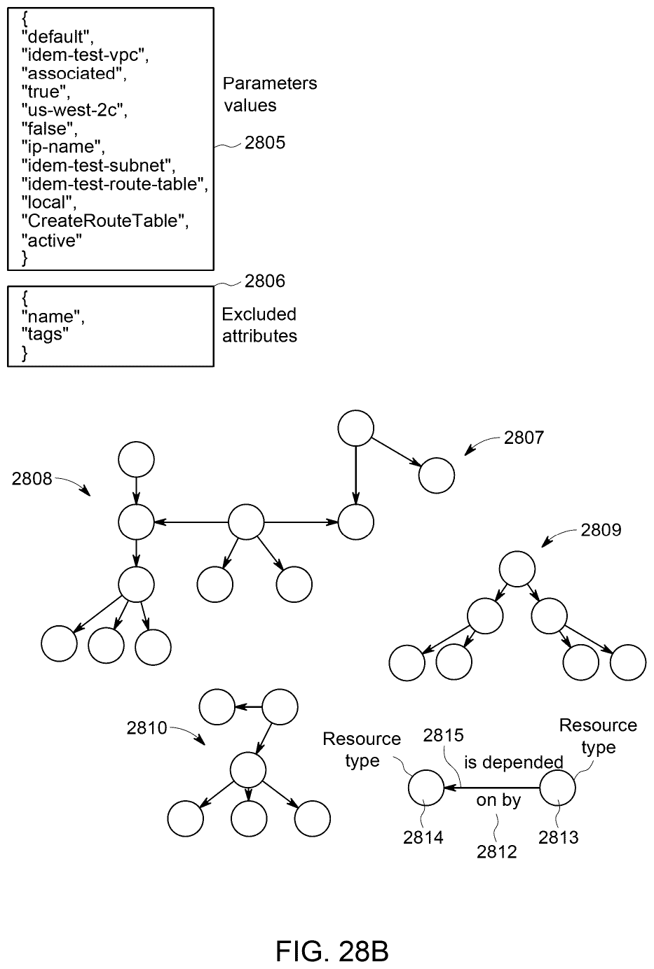

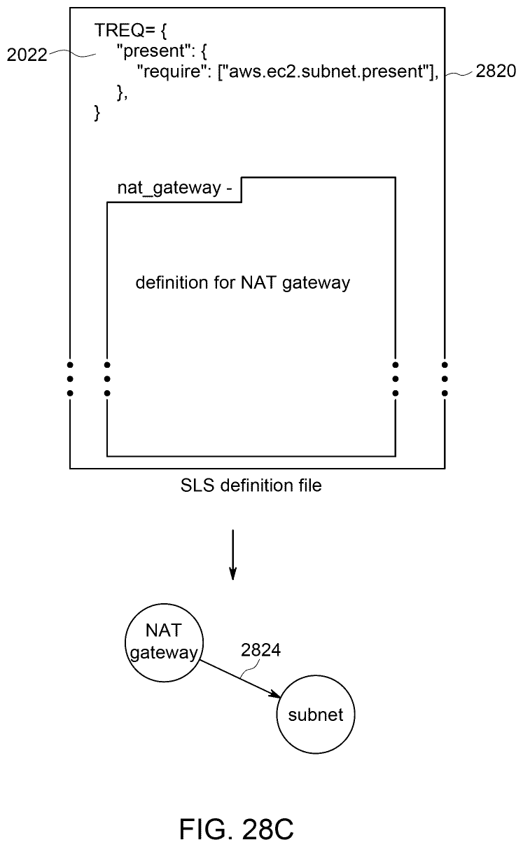

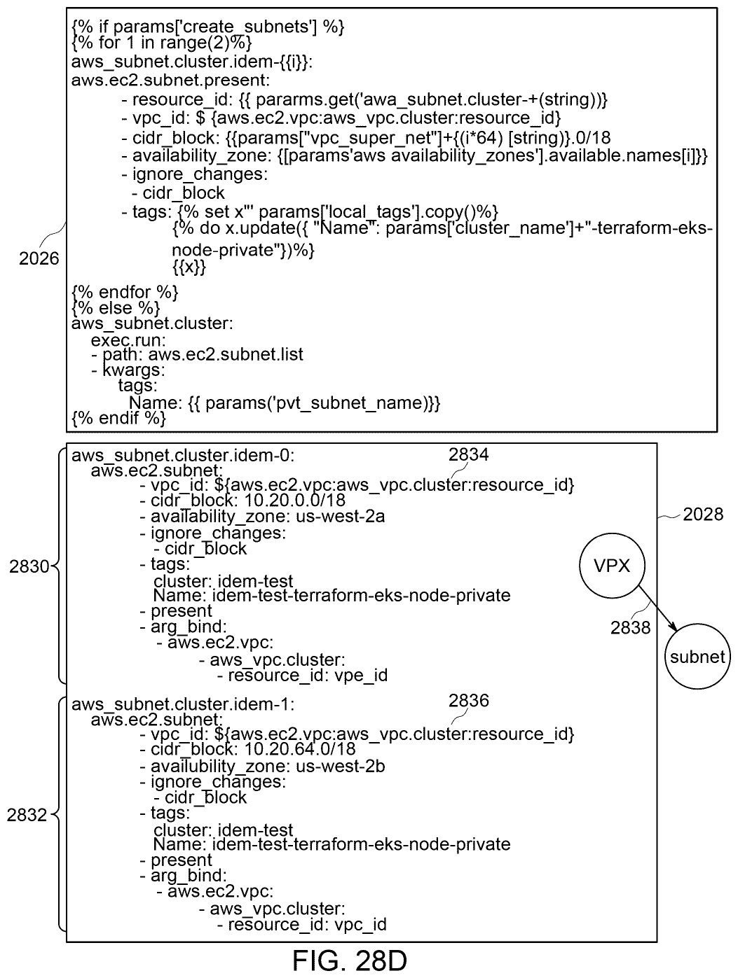

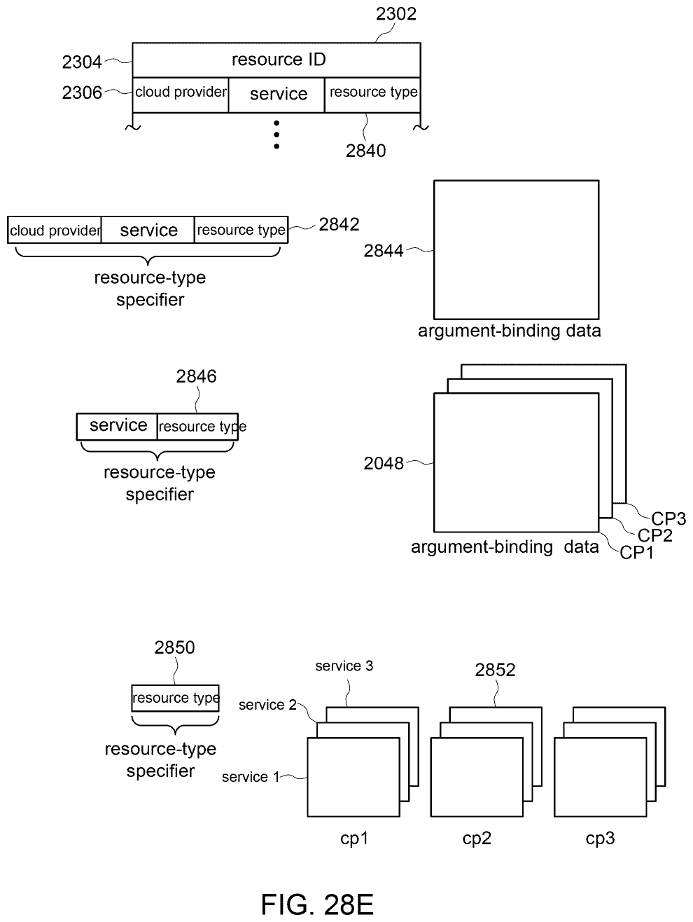

The current application is directed to methods and systems that automatically bind an attribute value, within a resource descriptor in a cloud-infrastructure-specification-and-configuration file, that references a parent resource descriptor via a resource identifier to the resource identifier in the parent resource descriptor. In a first subsection, below, a detailed description of computer hardware, complex computational systems, and virtualization is provided with reference to FIGS. 1-7. In a second subsection, an overview of the currently discussed IaC cloud-infrastructure-management service is provided, with reference to FIGS. 8-11. A third subsection provides an overview of the GraphQL API interface with reference to FIGS. 12-15. A fourth subsection provides an overview of YAML, JINJA, and SLS documents with reference to FIGS. 16-18C. In a fifth subsection, methods and systems that generate SLS specification-configuration files during an onboarding process are discussed with reference to FIGS. 19-27. Finally, in a sixth subsection, the currently disclosed argument-binding methods and systems are discussed with reference to FIGS. 28A-31J.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

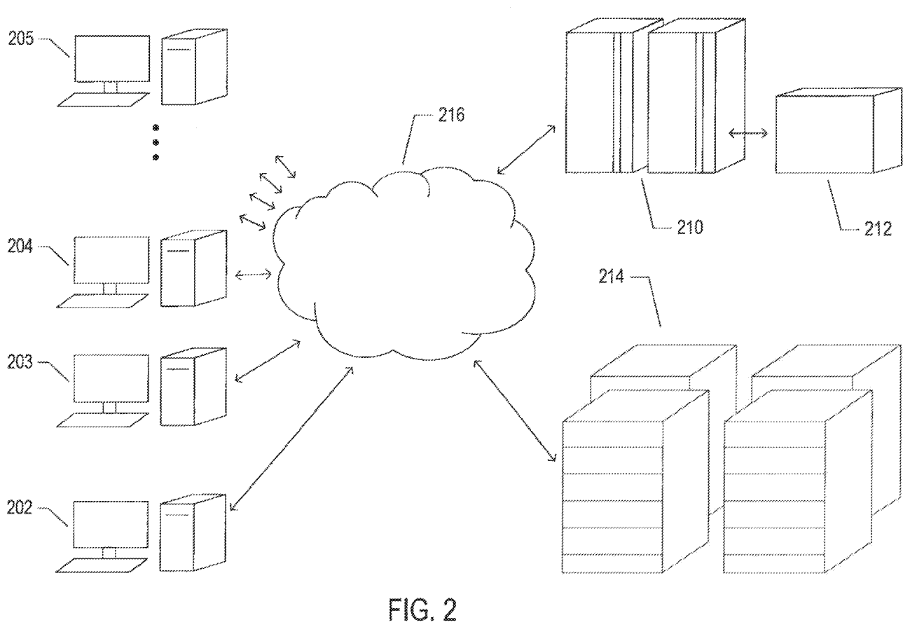

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

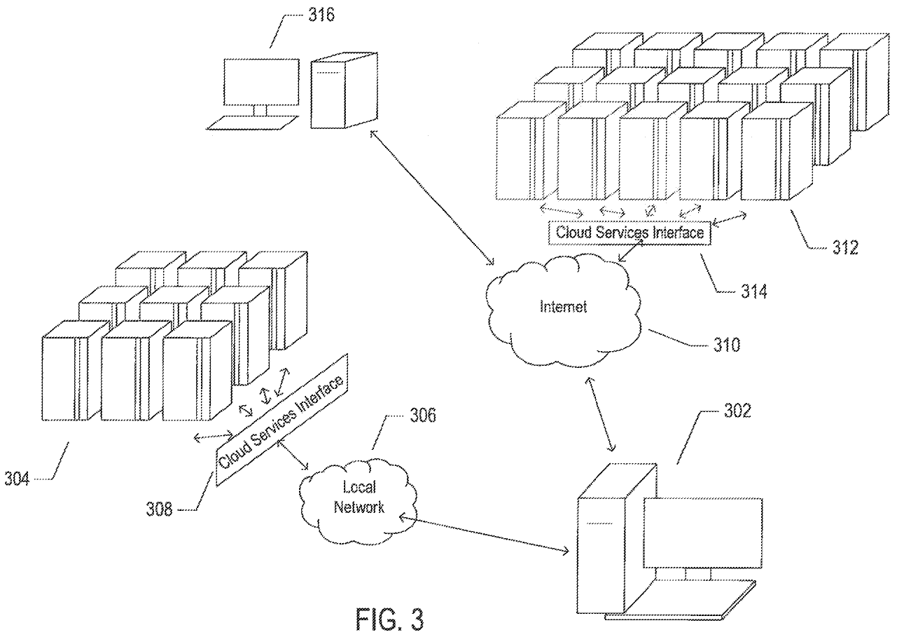

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

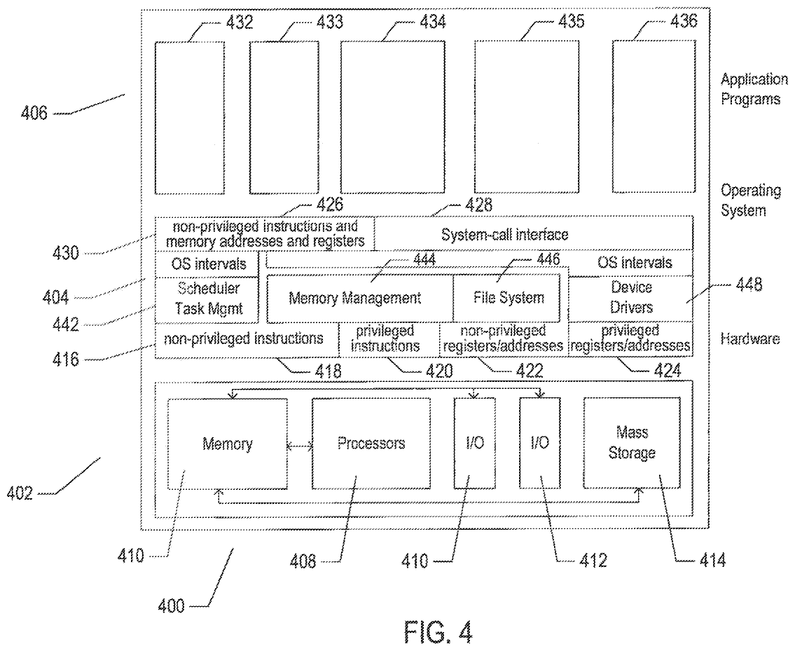

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

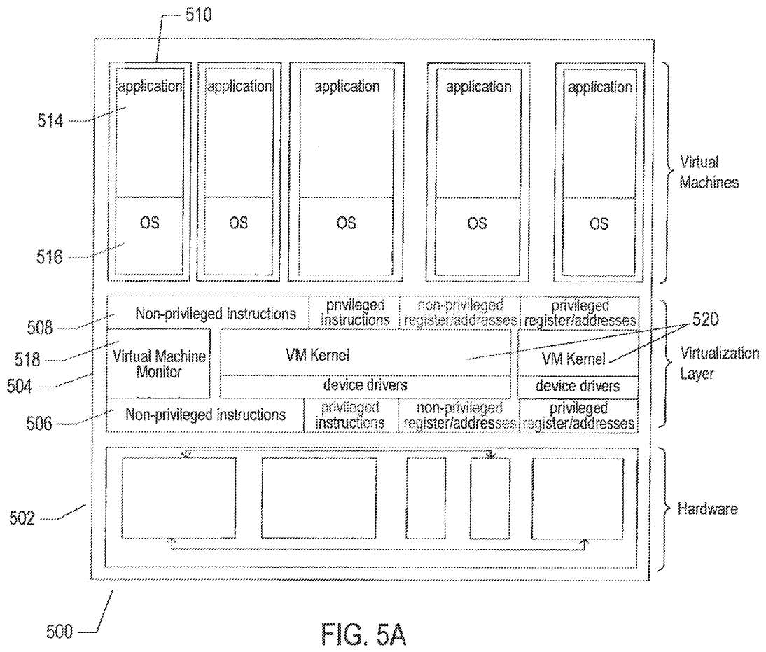

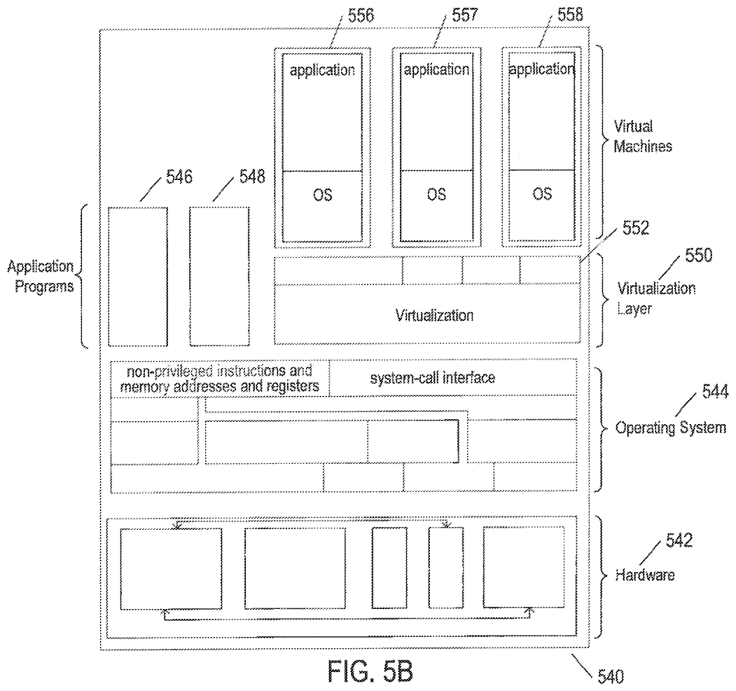

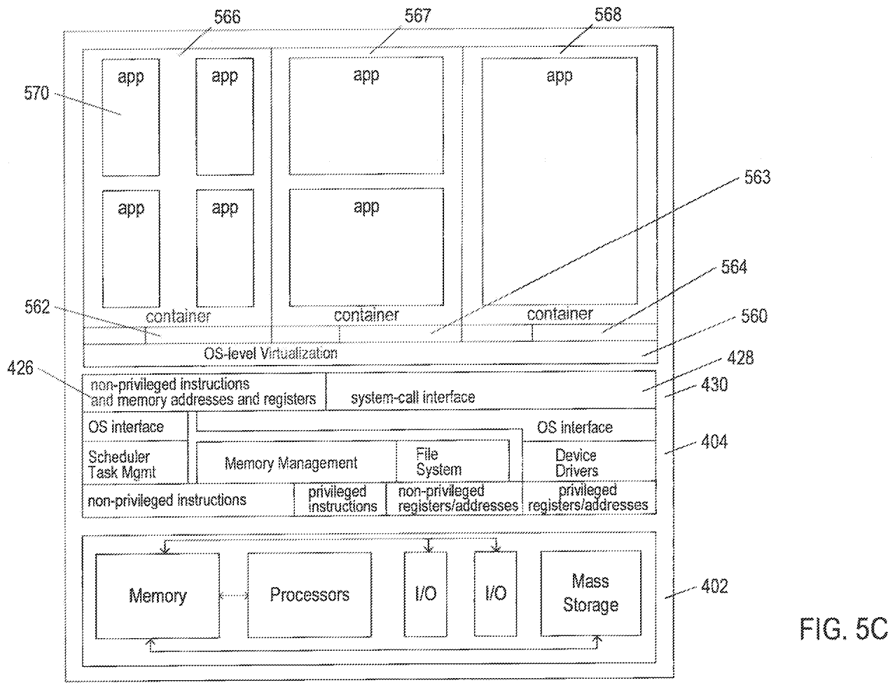

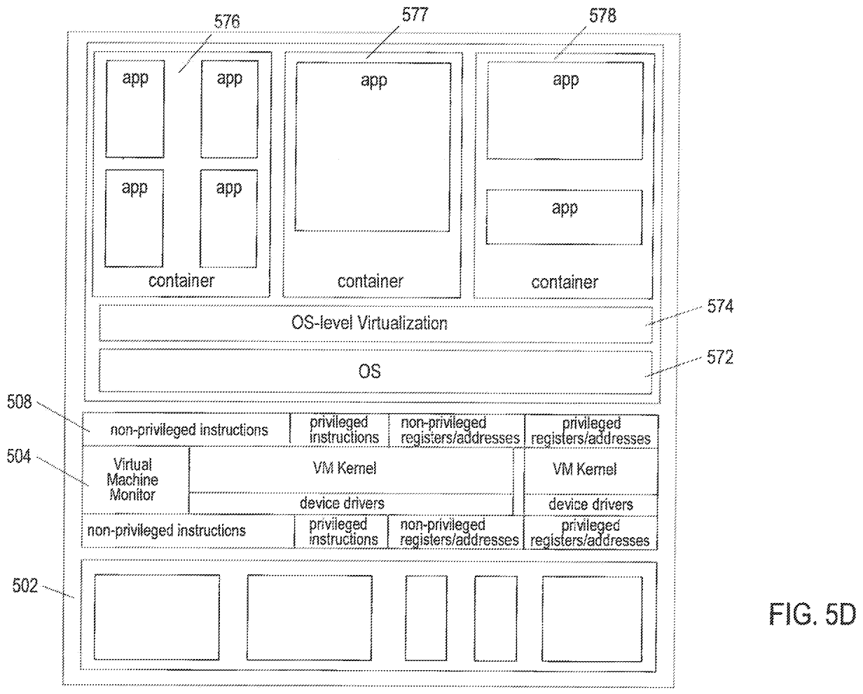

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

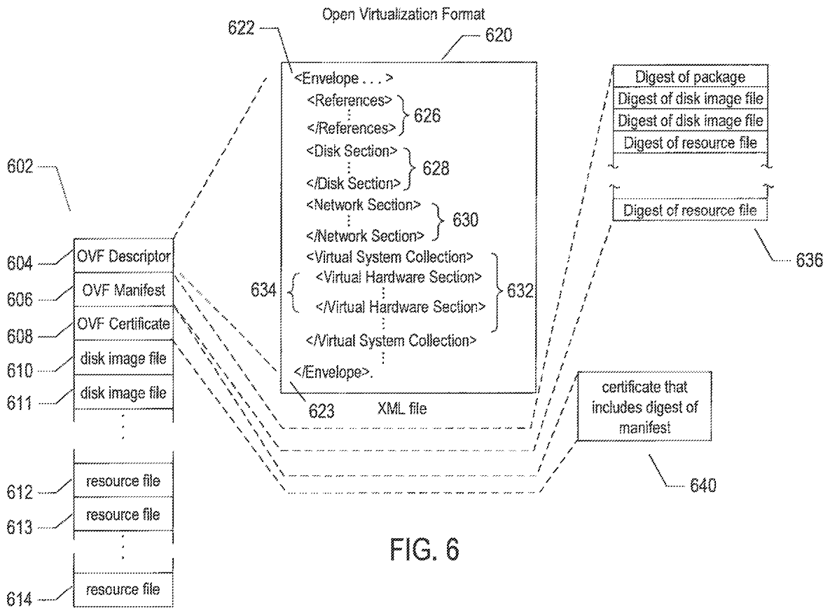

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting. distributing, and loading files. A virtual appliance is a software service that is delivered as a complete software stack installed within one or more virtual machines that is encoded within an OVF package.

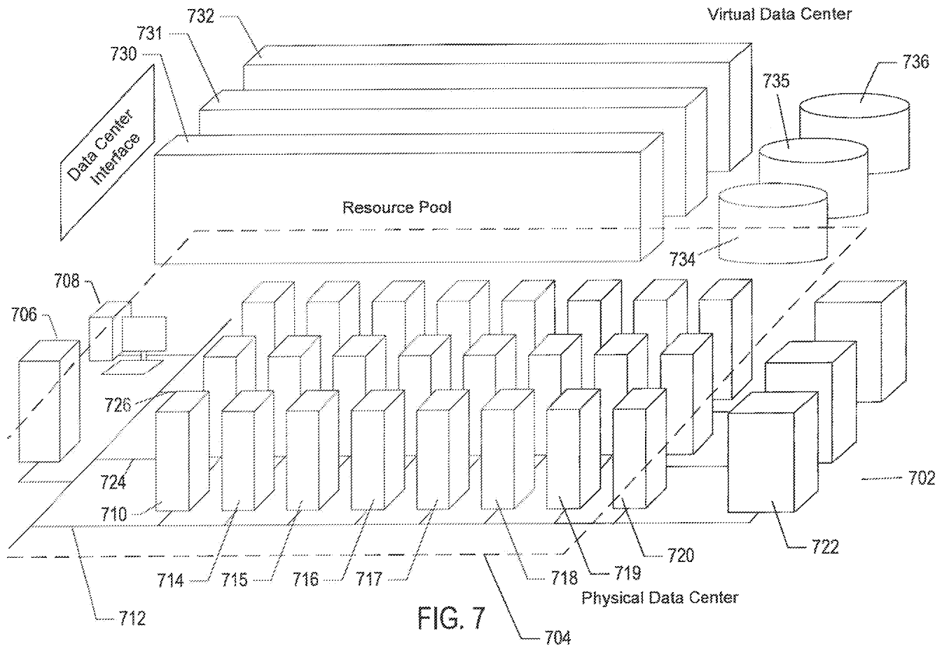

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### Overview of the Currently Discussed IaC Cloud-Infrastructure-Management Service

FIG. 8 illustrates a number of different cloud-computing facilities that provide computational infrastructure to an organization for supporting the organization's distributed applications and services. The cloud-computing facilities are each represented by an array of cabinets containing servers, data-storage appliances, communications hardware, and other computational resources, such as the array of cabinets 802. Each cloud-computing facility provides a management interface, such as management interface 804 associated with cloud-computing facility 802. The organization leases computational resources from a number of native-public-cloud cloud-computing facilities 802 and 806-810 and also obtains computational resources from multiple private-cloud cloud-computing facilities 811-813. The organization may wish to move distributed-application and distributed-service instances among the cloud-computing facilities to take advantage of favorable leasing rates, lower communications latencies, and desirable features and policies provided by particular cloud-computing facilities. In addition, the organization may wish to scale-up or scale-down the computational resources leased from different cloud-computing facilities in order to efficiently handle dynamic workloads. All of these types of operations involve issuing commands and requests through the management interfaces associated with the cloud-computing facilities. In the example shown in FIG. 8, cloud-computing facilities 802 and 806 are accessed through a first type of management interface, cloud-computing facilities 808 in 810 are accessed through a second type of management interface, and cloud-computing facilities 807 and 809 are accessed through a third type of management interface. The management interfaces associated with private-cloud cloud-computing facilities 811-813 are different from one another and from the native-public-cloud management interfaces.

The many different management interfaces represent a challenge to management and administration personnel within the organization. The management personnel need to be familiar with a variety of different management interfaces that may involve different command sets, different command-set syntaxes, and different features, In addition, the different management interfaces may accept different types of blueprints or cloud templates that specify the infrastructure and infrastructure configuration desired by the organization. It may be difficult for management personnel to determine whether certain desired features and functionalities easily accessed and obtained through certain types of management interfaces are even provided by cloud-computing facilities associated with other types of management interfaces. Different management interfaces may require different types of authentication and authorization credentials which further complicates management operations performed by management and administration personnel. These problems may even be of greater significance when computational resources are leased from cloud-computing facilities and configured and managed by automated management systems.

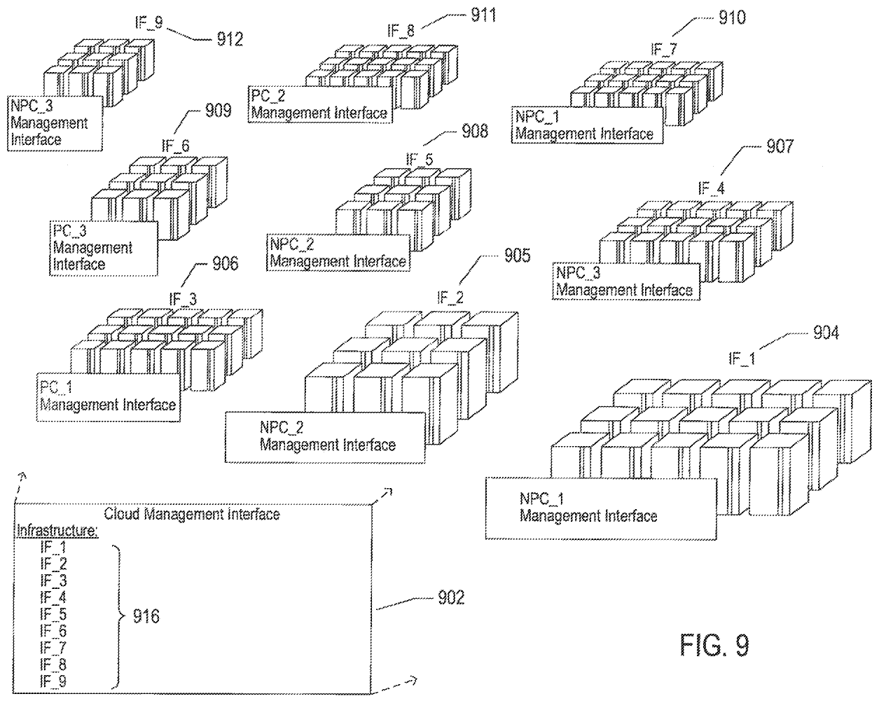

To address the problems associated with multiple different management interfaces to multiple different cloud-computing facilities, discussed in the preceding paragraph, the currently discussed IaC cloud-infrastructure-management service provides a single, universal management interface through which management and administration personnel as well as automated management systems define and deploy cloud-based infrastructure within many different types of cloud-computing facilities. FIG. 9 illustrates a universal-management-interface provided by the currently discussed IaC cloud-infrastructure-management service. The currently discussed IaC cloud-infrastructure-management service provides a cloud-management interface 902 through which both human management personnel and automated management systems can manage computational infrastructure provided by many different types of underlying cloud-computing facilities associated with various different types of management interfaces. The infrastructure deployed and configured within the various cloud-computing facilities is represented in FIG. 9 by the labels “IF_1” 904, “IF_2” 905, “IF_3” 906, “IF_4” 907, “IF_5” 908, “IF_6” 909, “IF_7” 910, “IF_8” 9011, and “IF_9” 912. The currently discussed IaC cloud-infrastructure-management service maintains the required authentication and authorization credentials for the different underlying cloud-computing facilities on behalf of human management personnel and automated management systems and automatically provides the required authentication and authorization credentials when accessing management interfaces provided by the different underlying cloud-computing facilities. One or more common types of cloud templates or blueprints are used to specify desired infrastructure and desired infrastructure configuration within the underlying cloud-computing facilities. Each different set of computational resources that together constitute an infrastructure within each of the cloud-computing facilities is visible, and can be managed, through the cloud-management interface 902, as indicated by the infrastructure labels 916 shown within the cloud-management interface.

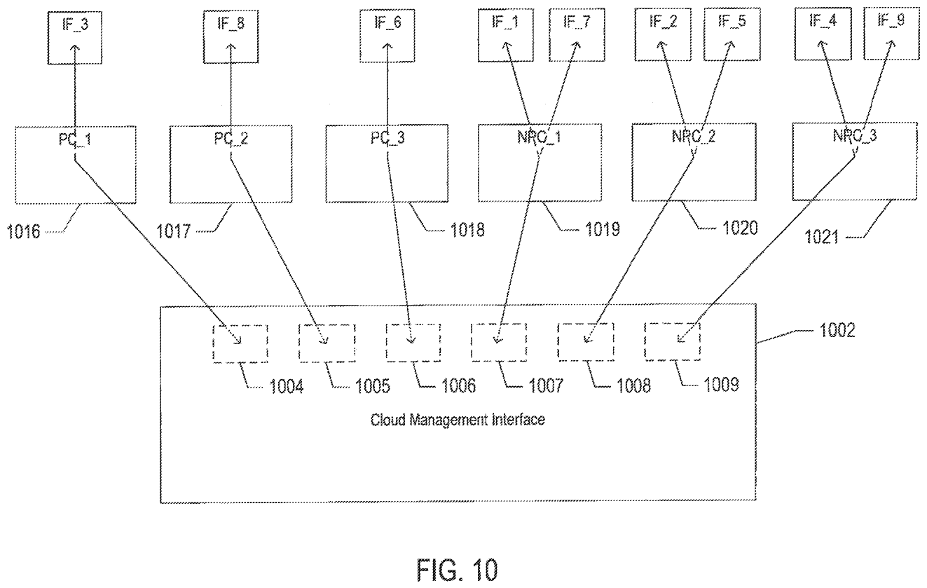

FIG. 10 illustrates the architecture of the currently discussed IaC cloud-infrastructure-management service. The IaC cloud-infrastructure-management service provides a cloud-management interface 1002 that includes a common or universal set of commands that can be used to deploy and configure infrastructure in many different types of private-cloud and native-public-cloud cloud-computing facilities that provide various types of cloud-management interfaces, allowing management and administration personnel and upstream automated infrastructure-management systems to deploy and configure infrastructure across the many different types of cloud-computing facilities through a common cloud-management interface 1002. The cloud-management interface 1002 is implemented by the IaC cloud-infrastructure-management service, discussed below. The IaC cloud-infrastructure-management service includes cloud-computing-facility-specific plug-ins, represented by dashed-line rectangles 1004-1009, that implement, together with control logic within the IaC cloud-infrastructure-management service, translation of the commands and features of the cloud-management interface 1002 to the commands and features of the underlying cloud-facility-specific management interfaces 1016-1021.

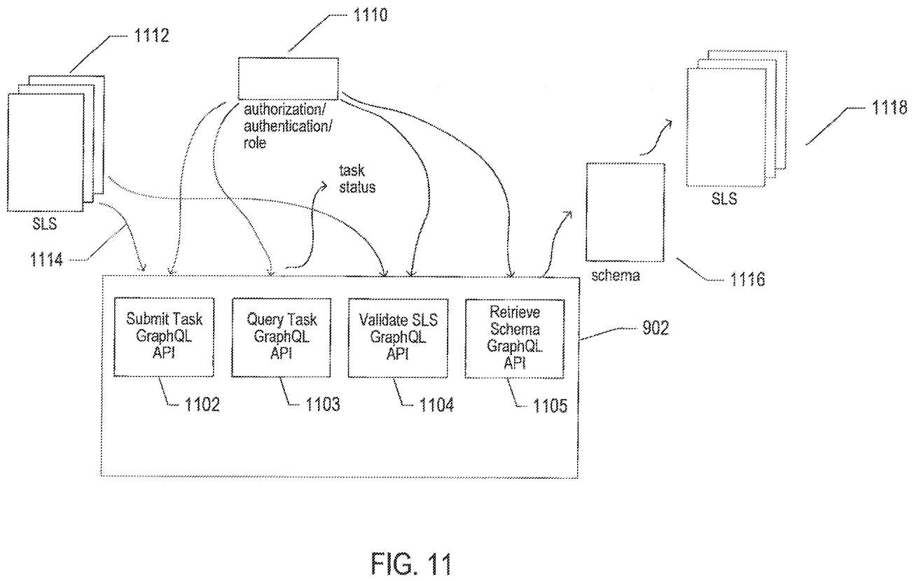

FIG. 11 illustrates the cloud-management interface provided by the currently discussed IaC cloud-infrastructure-management service. The cloud-management interface 902 includes four different GraphQL application programming interfaces (“APIs”): (1) Submit Task 1102, through which deployment-and-configuration commands are input to the IaC cloud-infrastructure-management service; (2) Query Task 1103, through which status queries for previously submitted deployment-and-configuration commands and requests are input to the IaC cloud-infrastructure-management service; (3) Validate SLS 1104, through which requests to validate SLS data are input to the IaC cloud-infrastructure-management service; and (4) Retrieved Schema 1105, through which the schemas for infrastructures within underlying computing-facilities can be requested from the IaC cloud-infrastructure-management service. Requests and commands input to the IaC cloud-infrastructure-management service are generally accompanied with an authorization/authentication/role certificate or token 1110, deployment-and-configuration tasks submitted to the Submit Task API are generally accompanied with SLS data 1112 (described below), and requests for validation of SLS data are accompanied with the SLS data to be validated, as indicated by curved arrows, such as curved arrow 1114, in FIG. 11. The schema 1116 returned when a command input to the Retrieve Schema API is executed is convertible into an SLS-data specification 1118 which can be input to the Submit Task API and/or modified and input to the Submit Task API.

There are, however, many different types of IaC cloud-infrastructure-management service or system implementations. For example, an IaC cloud-infrastructure-management service or system may be alternatively implemented as a collection of plug-ins that together comprise a cloud-infrastructure-management engine and a command-line interface (“CLI”). It is, for this reason, that the current document uses the phrase “service or system” to indicate that the currently discussed IaC cloud-infrastructure-management service is but one implementation approach to implementing cloud-infrastructure-management. To avoid repeating this phrase, the phrase “cloud-infrastructure manager” is used to refer to the various possible implementations of the currently discussed IaC cloud-infrastructure-management service or system.

### GraphQL Interface

FIG. 12 illustrates components of a GraphQL interface. The GraphQL interface is used as an API interface by various types of services and distributed applications. For example, as shown in FIG. 12, a server 1202 provides a service that communicates with a service client 1204 through a GraphQL API provided by the server. The service client 1204 can be viewed as a computational process that uses client-side GraphQL functionality 1206 to allow an application or user interface 1208 to access services and information provided by the server 1202. The server uses server-side GraphQL functionality 1210, components of which include a query processor 1212, a storage schema 1214, and a resolver component 1216 that accesses various different microservices 1218-1223 to execute the GraphQL-encoded service requests made by the client to the server. Of course, a GraphQL API may be provided by multiple server processes in a distributed application and may be accessed by many different clients of the services provided by the distributed application. GraphQL provides numerous advantages with respect to the Representational State Transfer (“REST”) interface technology, including increased specificity and precision with which clients can request information from servers and a potential for increased data-transfer efficiencies.

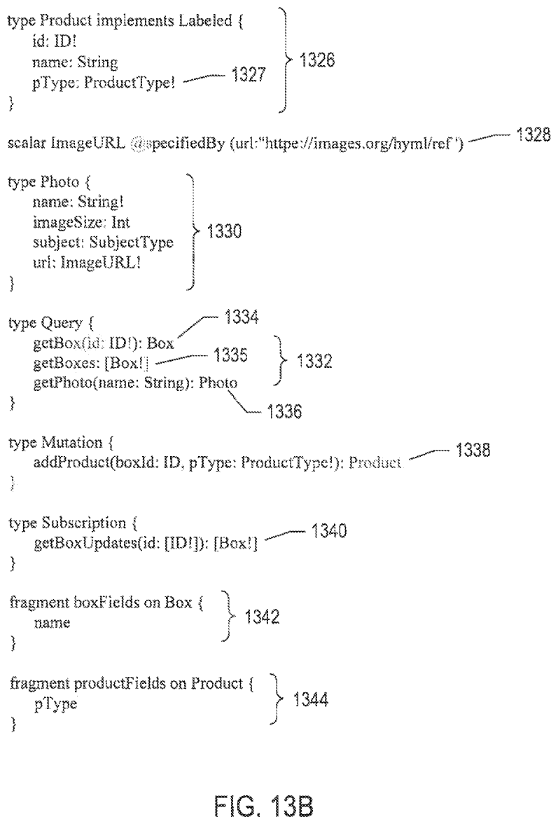

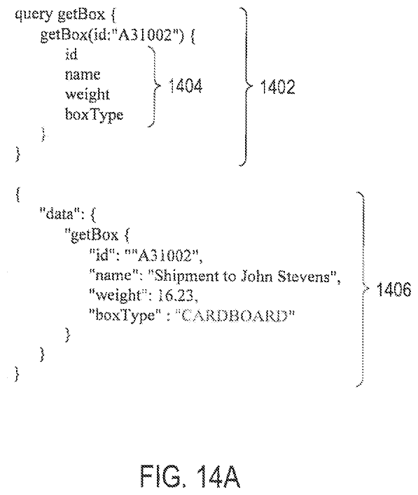

FIGS. 13A-E illustrate an example schema, an extension to that example schema, and queries, a mutation, and a subscription to illustrate the GraphQL query language. The example shown in FIGS. 13A-E does not illustrate all of the different GraphQL features and constructs, but a comprehensive specification for the GraphQL query language is provided by the GraphQL Foundation. A GraphQL schema can be thought of as the specification for an API for a service, distributed application, or other server-side entity. The example schema provided in FIGS. 13A-B is a portion of a very simple interface to a service that provides information about shipments of drafting products from a drafting-product retailer.

Three initial enumeration datatypes are specified in a first portion of FIG. 13A. The enumeration BoxType 1302 specifies an enumeration datatype with four possible values: “CARDBOARD.” “METAL.” “SOFT_PLASTIC,” and “RIGID_PLASTIC.” In the example schema, a box represents a shipment and the box type indicates the type of container in which the shipment is packaged. The enumeration ProductType 1304 specifies an enumeration datatype with eight possible values: “PENCIL_SET,” “ERASER_SET,” “INK_SET.” “PEN_SET.” “INDIVIDUAL_PENCIL,” “INDIVIDUAL_ERASER,” and “INDIVIDUAL_INK.” “INDIVIDUAL_PEN.” In the example schema, a shipment, or box, can contain products including sets of pencils, crasers, ink, and pens as well as individual pencils, erasers, ink, and pens. In addition, as discussed later, a shipment, or box, can also contain one or more boxes, or sub-shipments. The enumeration SubjectType 1306 specifies an enumeration datatype with four possible values: “PERSON,” “BUILDING,” “ANIMAL,” and “UNKNOWN.” In the example schema, the subject of a photograph is represented by one of the values of the enumeration SubjectType.

The interface datatype Labeled 1308 is next specified in the example schema. An interface datatype specifies a number of fields that are necessarily included in any object datatype that implements the interface. An example of such an object datatype is discussed below. The two fields required to be included in any object datatype that implements the interface Labeled include: (1) the field id 1309, of fundamental datatype ID; and (2) the field name 1310, of fundamental datatype String. The symbol “!” following the type specifier “ID” is a wrapping type that requires the field id to have a non-null value. The fundamental scalar datatypes in GraphQL include: (1) integers, Int; (2) floating-point values, Float; (3) Boolean values, Boolean; (4) string values, String; and (5) identifiers, ID. All of the more complex datatypes in GraphQL must ultimately comprise scalar datatypes, which can be thought of as the leaf nodes of a parse tree generated from parsing GraphQL queries, mutations, and subscriptions, discussed below. Wrapping datatypes include the non-null wrapping datatype discussed above and the list wrapping datatype indicated by bracketing a datatype, such as “[Int],” which specifies a list, or single-dimensional array, of integers or “[[Int]],” which specifies a list of lists or a two-dimensional matrix of integers.

The union Item 1312 is next specified in the example schema. A union datatype indicates that a field in an output data object can have one of the multiple datatypes indicated by the union specification. In this case, the datatype Item can be either a Box data object or a Product data object.

The Box object datatype 1314 is next specified in the example schema. An object datatype is a collection of fields that can have scalar-data-type values, wrapping-data-type values, or object data-type values. Because an object datatype may include one or more fields with object data-type values, object datatypes can describe hierarchical aggregations of data. The language “implements Labeled” 1315 indicates that the Box object datatype necessarily includes the interface Labeled fields id and name, discussed above, and those fields occur as the first two fields 1316 of the Box object datatype. The fields id and name represent a unique identifier and a name for the shipment represented by an instance of the Box object datatype. The additional fields in the Box object datatype include: (1) length 1317, of type Float, representing the length of the shipment container; (2) height 1318, of type Float, representing the height of the shipment container; (3) width 1319, of type Float, representing the width of the shipment container; (4) weight 1320, of type Float, representing the weight of the shipment container; (5) boxType 1321, of non-null enumeration type boxType, representing the type of shipment container; (6) contents 1322, an array of non-null Item data objects, representing the contents of the shipment; and (7) numItems 1323, of type Int, representing the number of items in the array contents. Since the field contents is an array of Item data objects, a box, or shipment, can contain one or more additional boxes, or sub-shipments. This illustrates how the GraphQL query language supports arbitrarily hierarchically nested data aggregations.

Turning to FIG. 13B, the example schema next specifies a Product 1326 object datatype that, like the Box object datatype, implements the interface Labeled and that additionally includes a field pType 1327 of enumeration type ProductType. An instance of the Product object datatype represents one of the different types of products that can be included in the shipment.

The example schema next specifies a custom scalar datatype ImageURL 1328 to store a Uniform Resource Locator (“URL”) for an image. The language “@specifiedBy ( )” is a directive that takes a URL argument that references a description of how a String serialization of the custom scalar datatype ImageURL needs to be composed and formatted in order to represent a URL for an image. GraphQL supports a number of built-in directives and allows for specification of custom directives. Directives are essentially specifications of run-time execution details that are carried out by a server-side query processor that processes GraphQL queries, mutations, and subscriptions, discussed below. As another example, built-in directives can control query-execution to omit or include certain fields in returned data objects based on variables evaluated at the query-execution time. It should also be noted that fields in object datatypes may also take arguments, since fields are actually functions that return the specified datatypes. Arguments supplied to fields, like arguments supplied to directives, are evaluated and used at query-execution time by query processors.

The example schema next specifies the Photo object datatype 1330, which represents a photograph or image that can be accessed through the service API specified by the schema. The Photo object datatype includes fields that represent the name of the photo, and image size, the type of subject of the photo or image, and in image URL.

The example schema next specifies three queries, a mutation, and a subscription for the root Query, Mutation, and Subscription operations. A query, like a database query, requests the server-side GraphQL entity to return information specified by the query. Thus, a query is essentially an information request, similar to a GET operation on a REST API. A mutation is a request to alter stored information and is thus similar to a PUT or PATCH operation on a REST API. In addition, a mutation returns requested information. A subscription is a request to open a connection or channel through which a GraphQL client receives specified information as the information becomes available to the GraphQL server that processes the subscription request. Thus, the various data objects specified in the schema provide the basis for constructing queries, mutations, and subscriptions that allow a client to request and receive information from a server. The example schema specifies three different types of queries 1332 that can be directed, by a client, to the server via the GraphQL interface: (1) getBox 1334, which receives an identifier for a Box data object as an argument and returns a Box data object in response; (2) getBoxes 1335, which returns a list or array of Box data objects in response; and (3) getPhoto 1336, which receives the name of a photo or image as an input argument and returns a Photo data object in response. These are three examples of the many different types of queries that might be implemented in the GraphQL interface. A single mutation addProduct 1338 is specified, which receives the identifier for a Box data object and a product type as arguments and, when executed by the server, adds a product of the specified product type to the box identified by the Box data-object identifier and returns a Product data object representing the product added to the box. A single subscription getBoxUpdates receives a list of Box data-object identifiers, as an argument, and returns a list of Box data objects in each response returned through the communications channel opened between the client and server for transmission of the requested information, over time, to the client. In this case, the client receives Box data objects corresponding to any of the boxes specified in the argument to the subscription getBoxUpdates when those Box data objects are updated, such as in response to addProduct mutations submitted to the server.

Finally, the example schema specifies two fragments: (1) boxFields 1342; and (2) productFields 1344. A fragment specifies one or more fields of an object datatype. Fragments can be used to simplify query construction by expanding a fragment, using the operator “ . . . ” in a selection set of a query, mutation, or subscription, as discussed below, rather than listing each field in the fragments separately in the selection set. A slightly different use of fragments is illustrated in example queries, below. In the current case, the fragment boxFields includes only the single field name of the Box data-object type and the fragment productFields includes only the single field name pType of the Product datatype.

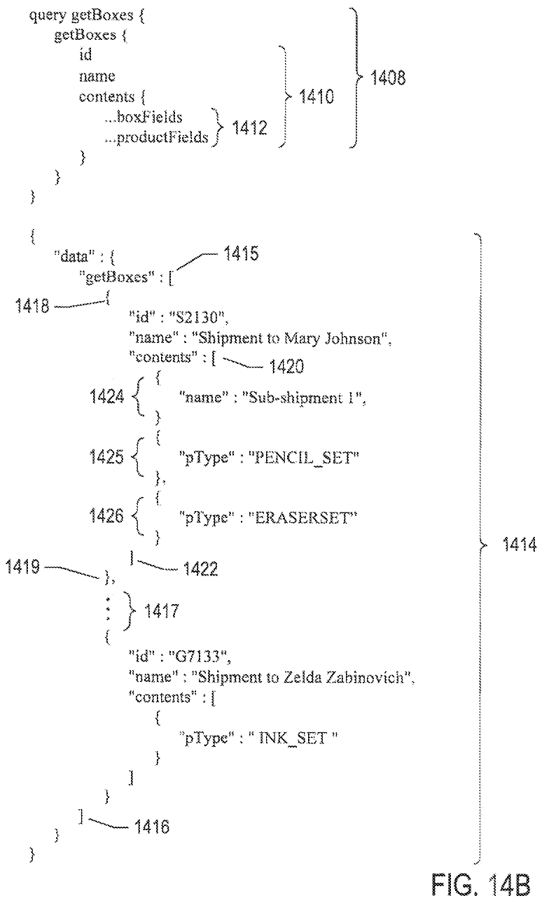

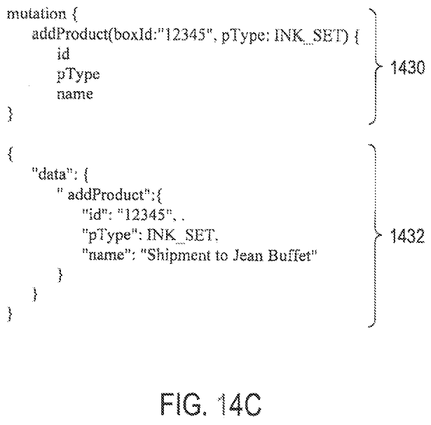

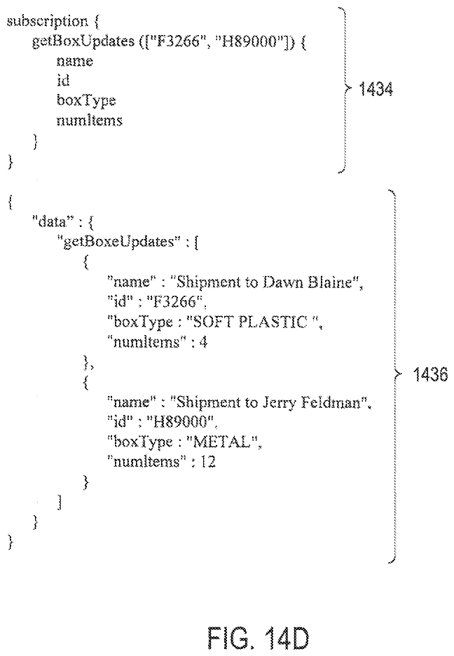

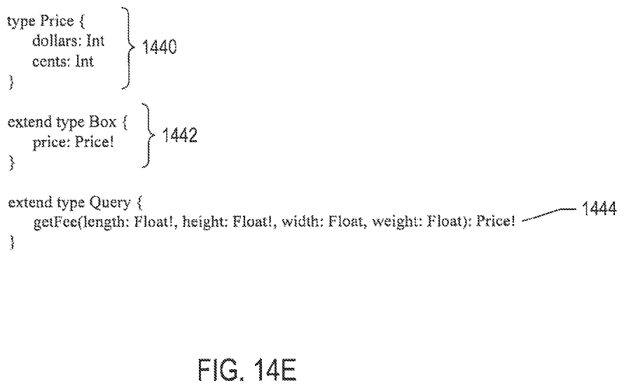

FIGS. 14A-D illustrates two example queries, an example mutation, and an example subscription based on the example schema discussed with reference to FIGS. 13A-B. FIG. 14A shows an example query 1402 submitted by a client to a server and the JavaScript Object Notation (“JSON”) data object returned by the server to the client. Various different types of data representations and formats can be returned by servers implementing GraphQL interfaces, but JSON is a commonly used data representation and formatting convention. The query 1402 is of the query type 1334 specified in FIG. 13B. The argument specified for the query is “A31002.” the String serialization of a Box identifier. A selection set 1404 for the query specifies that the client issuing the query wishes to receive only values for the id, name, weight, and boxType fields of the Box data object with identifier “A31002.” The JSON response to the query 1406 contains the requested information. This points to one of the large advantages provided by the GraphQL query language. A client can specify exactly the information the client wishes to receive from the server, rather than receiving predefined information for predefined queries provided by a REST interface. In this case, the client is not interested in receiving values for many of the fields in the Box data object and is able to use a selection set in the query to request only those fields that the client is interested in receiving.

FIG. 14B illustrates a second example query based on the example schema discussed with reference to FIGS. 13A-B. The second example query 1408 is of the query type 1335 specified in FIG. 13B. A selection set 1410 within the query requests that, for each Box data object currently maintained by the server, values for the id, name, and contents fields of the Box data object should be returned. The contents field has a list type and specifies a list of Item data objects, where an Item may be either a Box data object or a Product data object. A selection set 1412 for the contents field uses expansion of the boxFields and productFields fragments to specify that, for each Item in the list of Item data objects represented by the contents field, if the Item is a Box data object, then the value of the name field for that Box data object should be returned while, if the Item is a Product data object, then the value of the pType field of the Product data object should be returned. The JSON response 1414 to query 1408 is shown in the lower portion of FIG. 14B. The returned data is a list of the requested fields of the Box data object currently maintained by the server. That list begins with bracket 1415 and ends with bracket 1416. Ellipsis 1417 indicates that there may be additional information in the response for additional Box data objects. The requested data for the first Box data object occurs between curly brackets 1418 and 1419. The list of items for the contents of this Box data object begin with bracket 1420 and end with bracket 1422. The first Item 1424 in the list is a Box data object and the second two Item data objects 1425 and 1426 are Product data objects. The second example query illustrates that a client can receive a large amount of arbitrarily related information in one request-response interaction with a server, rather than needing to use multiple request-response interactions. In this case, a list of portions of multiple Box data objects can be obtained in one request-response interaction. As another example, in a typical REST interface, a client may need to submit a request to separately retrieve information for each Box data object contained within an outer-level Box data object, but, using a hierarchical object datatype, that information can be requested in a single GraphQL query.

FIG. 14C illustrates an example mutation based on the example schema discussed with reference to FIGS. 13A-B. The example mutation 1430 is of the mutation type 1338 specified in FIG. 13B. The mutation requests that the server add a product of type INK_SET to the Box data object identified by Box data-object identifier “12345” and return values for the id, pType, and name fields of the updated Box data object. The JSON response 1432 to query 1430 is shown in the lower portion of FIG. 14C. FIG. 14D illustrates an example subscription based on the example schema discussed with reference to FIGS. 13A-B. The example subscription 1434 is of the subscription type 1340 specified in FIG. 13B. The subscription requests that the server return, for updated Box data objects identified by Box data-object identifiers “F3266” and “H89000,” current values for the name, id, boxType, and numItems fields. One of the JSON responses 1436 to subscription 1434 returned at one point in time is shown in the lower portion of FIG. 14D.

FIG. 14E illustrates a second schema, based on the first example schema of FIGS. 13A-B and generated by extending the first example schema. The second schema may be used as an interface to a different service that returns shipment fees associated with Box data objects that represent shipments. The schema extension includes specification of a new Price data object 1440, extension of the object datatype Box to include an additional field price with a Price data-object value 1442, and extending the root Query operation type to include a getFee query 1444 that receives the length, height, width, and weight of a shipment and returns the corresponding shipment price or cost. Thus, GraphQL provides for extension of schemas to generate new extended schemas to serve as interfaces for new services, distributed applications, and other such entities.

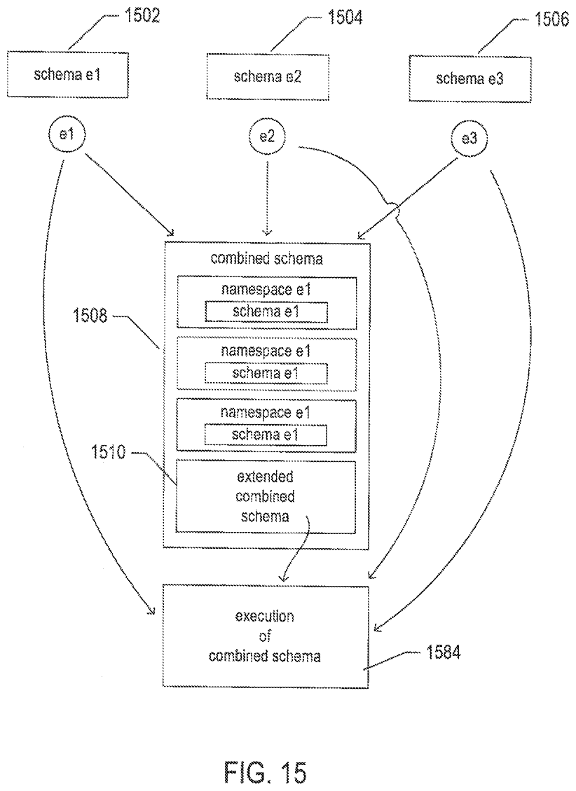

FIG. 15 illustrates a stitching process. Schema stitching is not formally defined by the GraphQL query-language specification. The GraphQL query-language specification specifies that a GraphQL interface is represented by a single schema. However, in many cases, it may be desirable to combine two or more schemas in order to produce a combined schema that is a superset of the two or more constituent schemas, allowing queries, mutations, and subscriptions based on the combined schema to employ object datatypes and other defined types and directives specified in two or more of the constituent schemas. There are multiple different types of implementations of schema stitching. In an example shown in FIG. 15, there are three underlying schemas 1502-1504. The stitching process combines these three schemas into a combined schema 1508. The combined schema includes the underlying schemas. In the illustrated approach to stitching, each underlying schema is embedded in a different namespace in the combined schema, which may include additional extensions 1510. The namespaces are employed in order to differentiate between identical identifiers used in two or more of the underlying schemas. Other approaches to stitching may simply add extensions to all or a portion of the type names defined in all of the underlying schemas in order to generate unique names across all of the underlying schemas. In the combined schema, queries, mutations, and subscriptions may use types from all of the underlying schemas and, in combined-schema extensions of underlying-schema types, a type defined in one underlying schema can be extended to reference a type defined in a different underlying schema. When a query, mutation, or subscription defined in the combined schema is executed, the execution 1514 may involve execution of multiple queries by multiple different services associated with the underlying schemas.

### YAML/JINJA and SLS Data

FIGS. 16A-D illustrate the YAML Ain′t Markup Language (“YAML”) data serialization language. YAML provides for representing data in text files. Certain features of YAML are illustrated by the YAML document shown in FIGS. 16A-D. A YAML document begins with three hyphens (1602 in FIG. 16A) and ends with three periods (1603 in FIG. 16D.) Multiple YAML documents can be included in a single text file. Comments begin with a “#” symbol followed by a space, such as the comment 1604. One of the fundamental constructs in YAML is a mapping of a scalar value to a scalar string, or name, such as the mapping 1605 of the integer value 35 to the name “x” and the mapping 1606 of the string value “Bill Johnson” to the name “Chairman.” YAML supports a variety of different types of scalars, as shown in the set of mappings 1607, including: integers encoded as decimal integers 1608, integers encoded as hexadecimal integers 1609, and integers encoded as octal integers 1610; floating-point numbers 1611; Boolean values “Yes” 1612 and “No” 1613, “true” 1614 and “false” 1615, and “On” and “Off” 1616; a value representing infinity 1617; and a value representing “not a number” 1618. On lines 1619, two text lines are mapped to the name “text_stuff,” with the symbol “|” used to indicate that newline characters in the text should be preserved. On lines 1620, two text lines are mapped to the name “f_text_stuff,” with the symbol “>” indicating that newlines should be removed in order to fold the text into a single text block. Text can be unquoted or quoted, as indicated by the examples on lines 1621. The “!!” operator can be used to explicitly assign types to values, as indicated on lines 1622.

Turning to FIG. 16B, another fundamental data structure supported by YAML is the sequence or list. Several different representations of lists are supported. In a first representation of a list 1623, the elements of the list are indicated by a preceding “-” and a space. In a second representation 1624, the elements of the list are contained within brackets and separated by commas and spaces. As indicated on lines 1625, a list can be mapped to a name. In the example of lines 1625, a list of animals is mapped to the character string, or name, “animals.” Note that indentation is used, as in the Python programming language, to indicate hierarchical structure.

Lines 1626 show a mapping of a more complex type of list to the name, or character string, “members.” In this example, the list is a list of blocks 1627-1629. Each block is preceded by a hyphen and a space. Each block contains a mapping of a character string to the character string “name” 1630, a mapping of two text lines to the character string “address” 1631, a mapping of an integer to the character string “age” 1632, and a mapping of an alphanumerically encoded phone number to the character string “phone” 1633. In the example of lines 1634 at the bottom of FIG. 16B and lines 1635 at the top of FIG. 16C, the mapping of the list of blocks to the character string “members” on lines 1626 of FIG. 16B is modified to include two additional lines in each block of the list. The two additional lines are specified using the anchor symbol “&” on lines 1636 at the bottom of FIG. 16B. The lines are included at the end of each block in the list using the reference prefix “<<: *” at the beginning of each of three lines referencing the anchor “chapter” 1637-1639. The modified list is equivalent to the list shown on lines 1640 of FIG. 16C. Finally, on line 1641 at the top of FIG. 16D, a more complex mapping that maps the list “[0, 1, 2]” to the list “[small, medium, large]” is shown. This mapping can alternatively be represented by the map sequence, or dictionary, shown on line 1642. The example YAML document shown in FIG. 16A-D does not, of course, provide a comprehensive description of the YAML data-representation language, but is instead intended to show some of the main features and constructs of YAML that are used in SLS documents, discussed below.

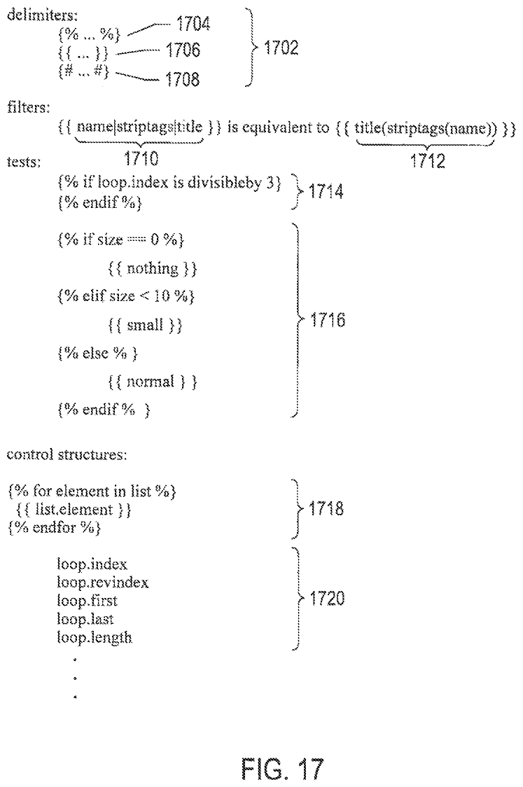

FIG. 17 illustrates certain features provided by the Jinja template engine that are used, in addition to YAML, for representing infrastructure in SLS documents. Jinja employs several types of delimiters to encode Jinja constructs. These are shown on lines 1702 of FIG. 17, with ellipses indicating that additional text is enclosed by the delimiters. A first type of delimiter 1704 is used to encapsulate tests, control structures, and other programming-language-like constructs. A second type of delimiter 1706 is used to encapsulate variables for output. A third type of delimiter 1708 is used to enclose comments. Pipe symbols “|” can be used to indicate sequences of function calls. For example, the delimited string “name|striptags|title” 1710 is equivalent to the character string 1712, which represents calling a function “title” with an argument that represents a value returned by calling the function “striptags” with the argument “name.” Jinja supports if statements, as shown by the example on lines 1714, and if-elseif-else statements, as shown by the example on lines 1716. Jinja provides a set of comparison operators used in if and if-elseif-else statements. Finally, Jinja provides various types of control structures, such as for-loops, as indicated on lines 1718. The for-loop control structure is accompanied with a number of Jinja loop variables 1720 that can be used in conditional expressions within loops. FIG. 17 does not provide a comprehensive list of examples of Jinja features and constructs, but is instead intended simply to show some of the main types of Jinja constructs that, in combination with YAML constructs and features, are used in SLS documents, described below.

The currently discussed cloud-infrastructure-management service is referred to as the “Idem service” in the remainder of this document, for reasons discussed in a following section. The Idem service, as discussed above, receives SLS data files that describe deployment and configuration of cloud-based infrastructure. SLS data files can be represented in various different data-serialization languages, including JSON, but a combination of YAML-like and Jinja-like formatting conventions, features, and constructs are most frequently used. An Idem state file is an SLS data file that represents configuration of a cloud-based infrastructure, and Idem SLS data files serve as blueprints or cloud templates input to the Submitted Task and Validate SLS APIs of the Idem-service management interface. There are, however, many different types of Idem implementations. Idem may be considered to be a data flow programming language, for example, and an Idem system may be implemented as a collection of plug-ins that together comprise a cloud-infrastructure-management engine and a command-line interface (“CLI”). In the current document, the Idem service introduced, above with reference to FIGS. 9-11, is used as an example cloud-infrastructure-management system in which the currently discussed automated methods for generating parameterized cloud templates corresponding to already deployed and configured cloud infrastructure can be incorporated, but the currently discussed automated methods can alternatively be incorporated in other types of Idem implementations.

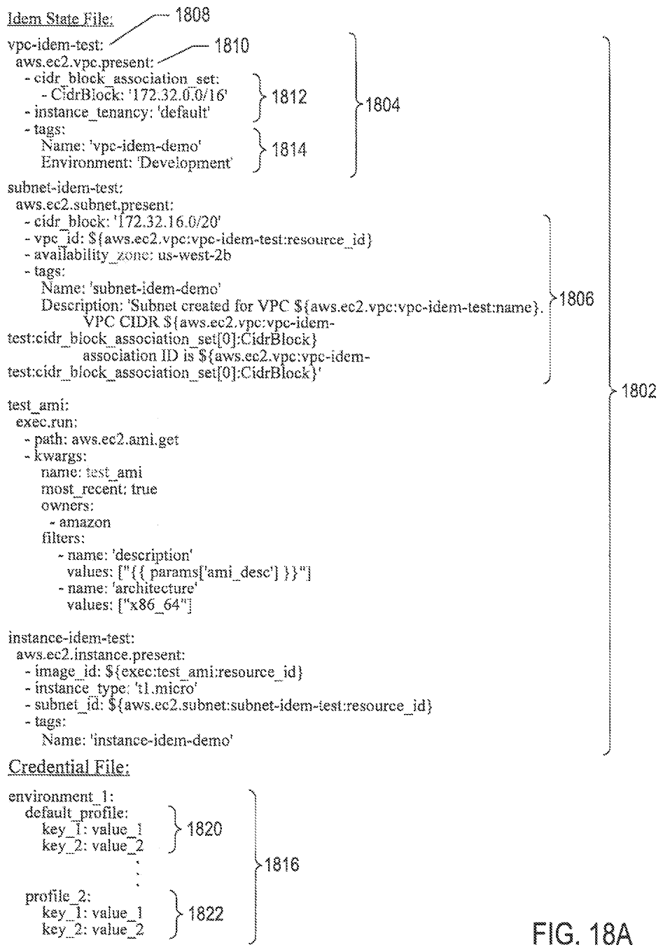

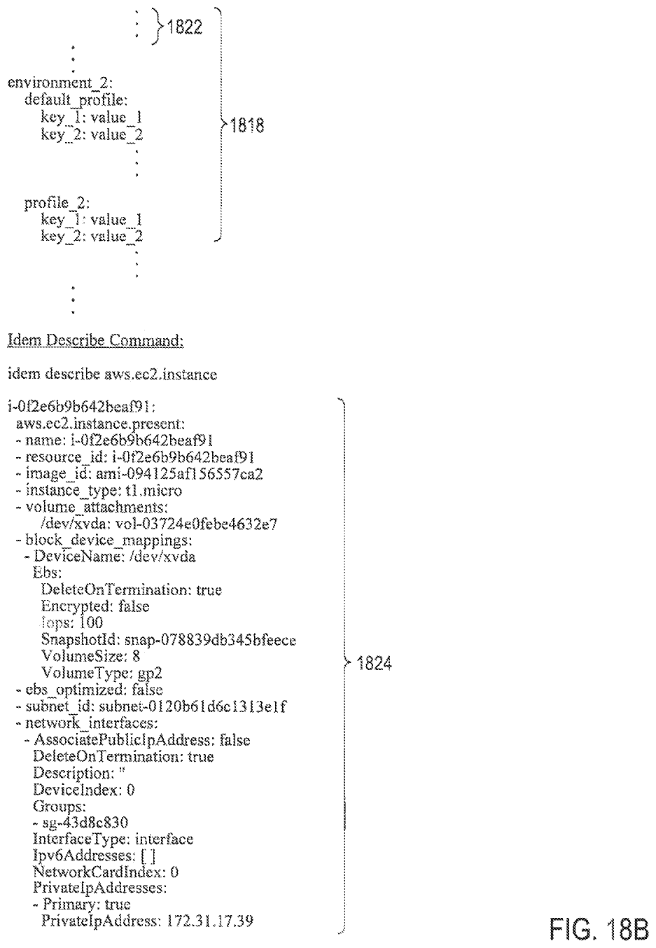

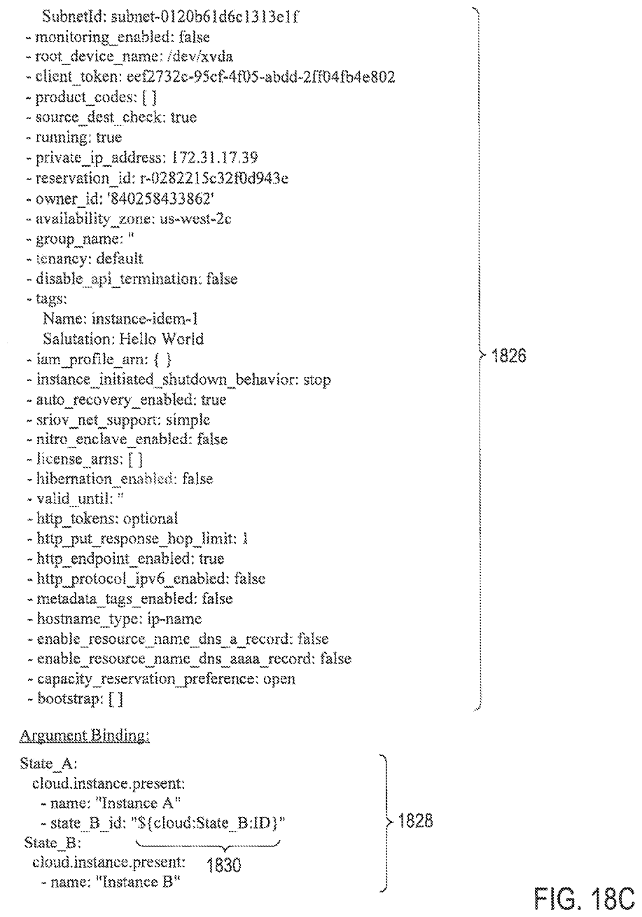

FIGS. 18A-C illustrate a structured layered state (“SLS”) data file and an SLS credential file as well as the output from an Idem describe command. A simple, example Idem state file is shown in the initial portion 1802 of FIG. 18A. The example SLS state file creates a virtual private cloud (“VPC”) for a virtual machine within an AWS cloud-computing facility and connects the VPC to an AWS subnet. A first portion of the example SLS state file 1804 specifies the VPC and a second portion of the example SLS state file 1806 specifies the subnet. Each resource includes a state name, such as “vpc-item-test” 1808 for the VPC, and a directive, or function, such as “aws.ec2.vpc.present” 1810. Directives include: (1) present, which indicates that, when the resource is not currently present in the infrastructure, the resource should be allocated, deployed, and configured according to the resource specification and that, when the resource is currently present in the infrastructure, the Idem service resource should ensure that the current deployment and configuration of the resource corresponds to the resource specification; (2) absent, which indicates that, when the resource is currently allocated and deployed, the resource should be removed; and (3) describe, which requests that the Idem service return information about the resource. Resources are specified using a plug-in/resource-group/resource-type tuple, such as “aws.cc2.vpc” in directive 1810. The plug-in portion of the plug-in/resource-group/resource-type tuple refers to a plug-in associated with a particular cloud-computing facility or cloud provider which provides the executables for accessing the particular cloud-computing facility and/or a set of cloud-computing facilities managed by the cloud provider. A resource specification includes a list of attribute/value pairs, generally including property/value pairs 1812 tag/value pairs 1814. Of course, real-world Idem state files may contain descriptions of hundreds or thousands of resources and, in addition, a blueprint or cloud templates may include multiple hierarchically organized SLS state files. The resource-group portion of the plug-in/resource-group/resource-type tuple refers to a group or class containing multiple types of resources and the resource-type portion of the plug-in/resource-group/resource-type tuple refers to a particular type of resource, such as a virtual machine or a subnet, which is a partition of the host-address space of a virtual-private-network-address space.

The form of an SLS credential file is shown in a lower portion 1816 of FIG. 18A and an upper portion 1818 of FIG. 18B. The SLS credential file contains a block of authentication/authorization information for one or more environments, each of which corresponds to plug-ins for different types of cloud-computing-facility management interfaces. The first portion 1816 of the example SLS credential file shown in FIG. 18A contains a block of authentication/authorization information for a first environment. Each block contains authentication/authorization information for one or more profiles, such as profiles 1820 and 1822 in the block for the first environment, including a default profile 1820. The authentication/authorization information is encoded as a set of attribute/value pairs, such as the name of a particular type of authentication/authorization information, such as an access key, and the alphanumerically encoded access key. SLS credential files are used to input authentication/authorization information to the Idem-service management interface so that the authentication/authorization information can be maintained by the Idem-service management interface and used by the Idem service to access functionality provided by the management interfaces of cloud-computing facilities via the various plug-ins.

The lower portion 1824 of FIG. 18B and the upper portion 1826 of FIG. 18C show the output of an Idem-service describe command executed with respect to the infrastructure described in the Idem state file 1802 shown in FIG. 18A. The output of the Idem-service describe command has a YAML-like format and can be used to generate a corresponding Idem state file that can be subsequently used to modify and enforce the configuration of the represented infrastructure, as discussed below. A final portion 1828 of FIG. 18C illustrates argument binding in SLS data files. The character string “${cloud: State_B: ID}” represents a reference to an attribute value of an attribute in an SLS data file generated by prior execution of a portion of an SLS data file. In the example shown in the final portion of FIG. 18C, the string “${cloud: State_B: ID}” references the name of the resource State_B once that name is obtained via an Idem-service state command. Moreover, execution of the Idem-service state command orders execution of operations related to specified resources to ensure that argument bindings refer to valid attribute values.

Methods and Systems that Generate a Set of SLS Specification-and-Configuration Files During an On-Boarding Process

As discussed above, the current application discloses a cloud-infrastructure-management service referred to as the “Idem service.” This name is derived from the term “idempotent.” An idempotent operation is an operation that can be first applied to an object or entity and, when the object or entity is not subsequently altered by other operations, can be again applied to the object or entity without changing the object or entity. One example of an idempotent operation is the computational operation x=x mod 5, where the initial value of x is 16. The first application of the operation x=x mod 5 sets the value of x to 1. Provided that the value of x is not altered by some other operation, a second application of the operation x=x mod 5 results in the value of x remaining 1, and this is true for any number of repeated applications of the operation x=x mod 5 provided that the value of x is not altered by application of some other operation.

FIG. 19 illustrates a fundamental control loop involving the Idem service. This control loop involves the Idem-service state command, mentioned above, which applies an SLS-data blueprint or cloud template to a cloud-computing facility. In the case that no infrastructure has yet been deployed and configured within the cloud-computing facility on behalf of the individual or organization submitting the Idem-service state command to the management interface of the Idem service, the Idem service creates, deploys, and configures infrastructure on the cloud-computing facility according to the SLS-data blueprint or cloud template. When the resulting infrastructure is not subsequently altered by other commands or events, then, when the individual or organization again submits the same SLS-data blueprint or cloud template in a subsequent Idem-service state command to the management interface of the Idem service, the infrastructure is not changed by the subsequent Idem-service state command. However, in the case that the infrastructure has been altered by various events following the initial creation, deployment, and configuration of the infrastructure, submission of the same SLS-data blueprint or cloud template in a subsequent Idem-service state command to the management interface of the Idem service returns the infrastructure to the state that the infrastructure had upon initial creation, deployment, and configuration. Thus, the Idem-service state command associated with a particular SLS-data blueprint or cloud template is idempotent, and resubmission of an Idem-service state command associated with a particular SLS-data blueprint or cloud template can be used to control unintended departures of the state of cloud-based infrastructure, referred to as “enforcement,” without the risk of causing unintended changes to the state of the infrastructure defined by the SLS-data blueprint or cloud template.

The idempotency of the Idem-service state command is reflected in the fundamental control loop 1902 illustrated in FIG. 19. There are two possible starting points 1904 and 1906 for the control loop 1902. Assuming that the loop begins at the starting point 1904, the loop begins with an SLS-data blueprint or cloud template 1908 that describes desired infrastructure to be created, deployed, and configured within a cloud-computing facility. The SLS-data blueprint or cloud template is referenced by an Idem-service state command 1910 which is submitted to the Idem service for execution 1912. Execution of the Idem-service state command 1910 produces deployed and configured infrastructure 1914 with a state corresponding to a desired state represented by the SLS-data blueprint or cloud template. Subsequent submission of an Idem-service describe command 1916 result in execution of the describe command by the Idem service 1918 which, in turn, produces Idem-service-describe-command output 1920 that represents the current state of the infrastructure. At this point, if the output from the Idem describe command does not reflect the desired state of the infrastructure, the original SLS data can be referenced by a resubmitted Idem-service state command to enforce the originally desired infrastructure state. This enforcement operation is used to correct infrastructure drift, where “infrastructure drift” means an unintended departure of the state of the infrastructure from the desired state due to intervening events or operations. By contrast, if the loop started at starting point 1906, then the output from the Idem-service describe command can be translated into SLS data that can be subsequently used to enforce the infrastructure state represented by the SLS data. Yet another possibility is that the infrastructure state represented by the describe-command output may be used to generate corresponding SLS data which can then be modified in order to generate a new infrastructure state. Thus, the fundamental control loop may continue to iterate in order to maintain the state of the infrastructure in a desired state, with modifications to the SLS-data blueprint or cloud template made to alter the infrastructure state in response to changing goals or conditions.

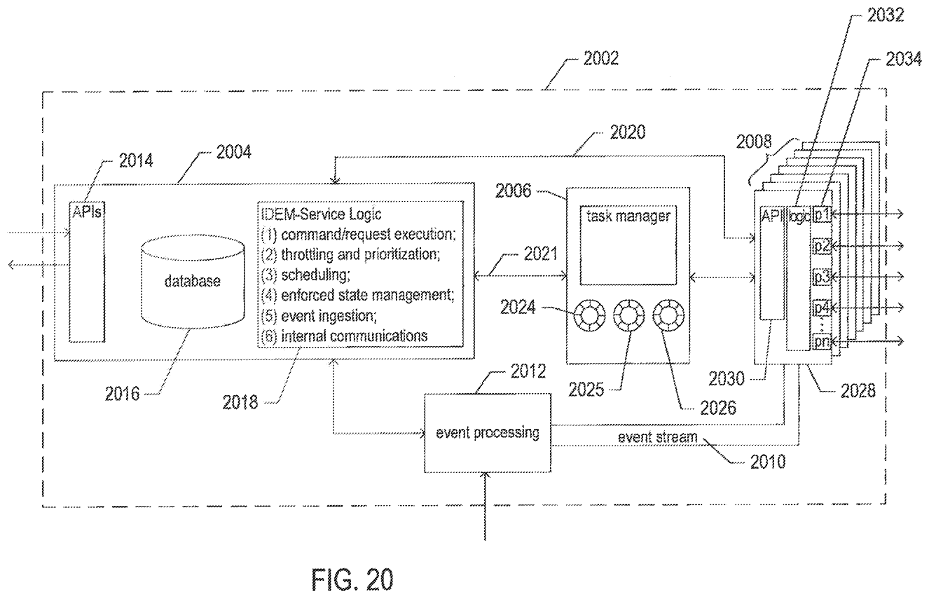

FIG. 20 illustrates one implementation of the Idem service. The Idem service 2002 includes an Idem-service frontend 2004, a task manager 2006, multiple Idem-service workers 2008, with the number of Idem-service workers scalable to handle dynamic workloads, an event stream 2010, and an event-processing component 2012. The Idem-service frontend 2004 includes the previously discussed set of GraphQL APIs 2014 and a database 2016 for storing information related to managed infrastructure and received Idem requests and commands. The frontend additionally includes Idem-service logic 2018 that implements command/request execution, throttling and prioritization, scheduling, enforced-state management, event ingestion, and internal communications between the various components of the Idem service. Throttling involves managing the workload accepted by the Idem service to ensure that sufficient computational resources are available to execute received commands and requests. Prioritization involves prioritizing execution of received Idem commands and requests. Scheduling involves preemption of long-running Idem-command-and-request executions. Enforced state management involves maintaining a representation of the last enforced state of a particular infrastructure managed by the Idem service in order to facilitate subsequent command/request execution. Event ingestion involves receiving, storing, and acting on events input to the Idem-service frontend by the event-processing component 2012. The various components of the Idem service communicate by message passing, as indicated by double-headed arrows 2020-2022. The task manager 2006 coordinates various stages of execution of Idem commands and requests using numerous task queues 2024-2026. Each Idem-service worker, such as Idem-service worker 2028, presents an Idem-service worker API 2030 and includes logic 2032 that implements Idem-command-and-request execution. Each Idem-service worker includes a set of one or more plug-ins, such as plug-in 2034, allowing the Idem-service worker to access the management interfaces of cloud-computing facilities on which infrastructure managed by the Idem service is deployed and configured. As they execute commands and requests, Idem-service workers publish events to the event stream 2010. These events are monitored and processed by the event-processing component 2012, which filters the events and forwards processed events to the Idem-service frontend.

Although, as discussed above, the Idem service provides many advantages to those who manage and administer cloud infrastructure, it may be difficult for managers and administrators who are currently managing deployed cloud infrastructure using currently available, non-Idem management tools, to transition to using Idem. Although the above-described SLS-data blueprints or cloud templates allow cloud-infrastructure deployments and configurations to be easily and intuitively created for deployment and configuration of cloud infrastructure via the Idem-service state command, there is still a learning curve associated with adopting the SLS-data-cloud-template approach. This learning curve involves learning how to encode cloud-infrastructure deployment and configuration in a set of SLS data files that together comprise a parameterized cloud template, but also involves the potentially difficult task of determining the resources and associated resource attributes for cloud infrastructure already deployed in cloud-computing facilities. Quite often, the cloud infrastructure that was initially specified through other types of management interfaces has changed, over time, so that it no longer corresponds to original specifications, a phenomenon referred to as “drift.” In order to transition already deployed cloud infrastructure to being managed by the Idem-service, a manager or administrator may need to spend significant amounts of time determining the resources and resource attributes for the already deployed cloud infrastructure through tedious and complex management-interface operations. Moreover, manual transitioning of already deployed and configured cloud infrastructure to management by the Idem-service may be error-prone. Because of problems associated with drift, submitting an SLS cloud template manually prepared from information obtained through another type of cloud-infrastructure management interface can result in the Idem service attempting to restore the deployment and configuration encoded in the SLS cloud template, which may result in unintended changes to the already deployed cloud infrastructure that, in turn, may result in operational anomalies and even system failures.

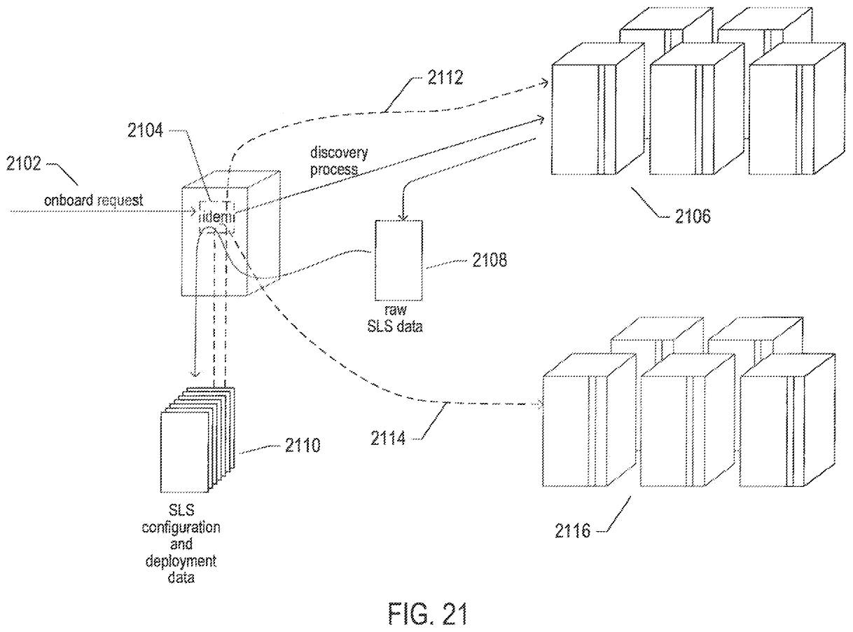

To resolve the problems discussed in the preceding paragraph, an automated method for generating parameterized cloud templates corresponding to already deployed and configured cloud infrastructure has been developed and incorporated into the Idem service. FIG. 21 illustrates the currently discussed methods and systems that generate parameterized cloud templates corresponding to already deployed and configured cloud infrastructure. The term “parameterized” indicates that the cloud templates include resource-id bindings and/or parameter function calls, discussed below. These currently discussed methods and systems are invoked by an onboard request or command 2102 submitted to the Idem service 2104. The terms “onboard” and “onboarding” refer to the process of transitioning management of cloud infrastructure from a non-Idem management service or system to the Idem service. Upon receiving the onboard request or command, the Idem service connects to the cloud provider associated with the already deployed and configured cloud infrastructure 2106 and carries out a discovery process based on the above-described Idem describe command. This process results in generation of a YAML-like description 2108 of the already deployed and configured cloud infrastructure, discussed above with reference to FIGS. 18B-C. In alternative implementations, other types of data-representation languages can be used in place of YAML. The YAML-like description 2108 is referred to as “raw SLS data.” The raw SLS data is then automatically processed by the Idem service to produce a parameterized cloud template 2110 that corresponds to the already deployed and configured cloud infrastructure, as discussed, in detail, below. The parameterized cloud template can then be immediately used for management of the already deployed and configured cloud infrastructure, as indicated by dashed arrow 2112, and/or can be used, as indicated by dashed arrow 2114, as a template for deploying equivalent cloud infrastructure in a new cloud-computing facility 2116. The onboard request allows an administrator or manager to quickly and accurately transition existing cloud infrastructure to being managed by the Idem service, without the risk of operational anomalies or system failures due to drift or to the administrator's or manager's failure to understand SLS-based cloud-infrastructure specification and/or failure to accurately emulate the already deployed cloud-infrastructure specification in a manually prepared cloud template, and thus represents a significant and important improvement to the Idem service and to general management and administration of cloud-based infrastructure. In essence, the currently discussed methods and systems represent an improved computational system for management and administration of cloud-based infrastructure.

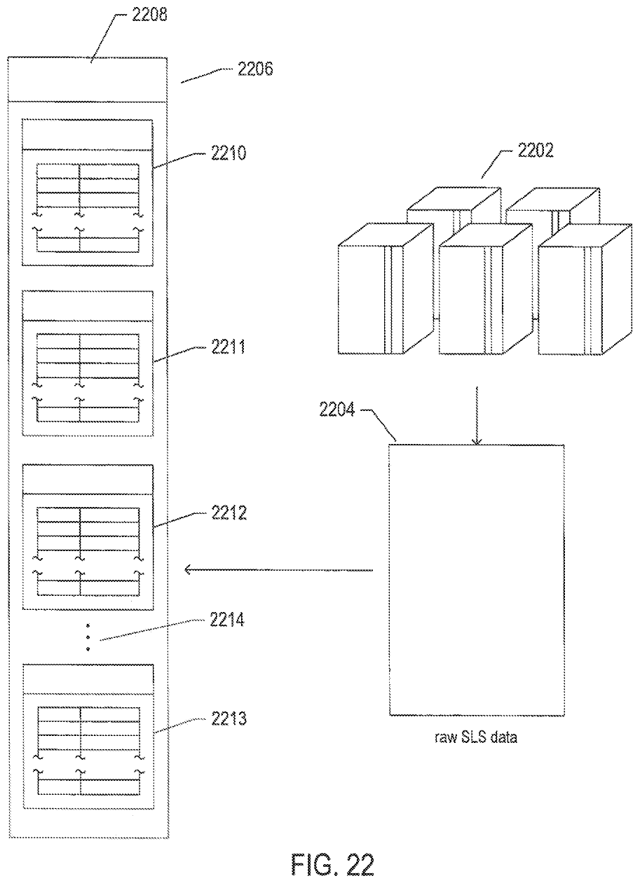

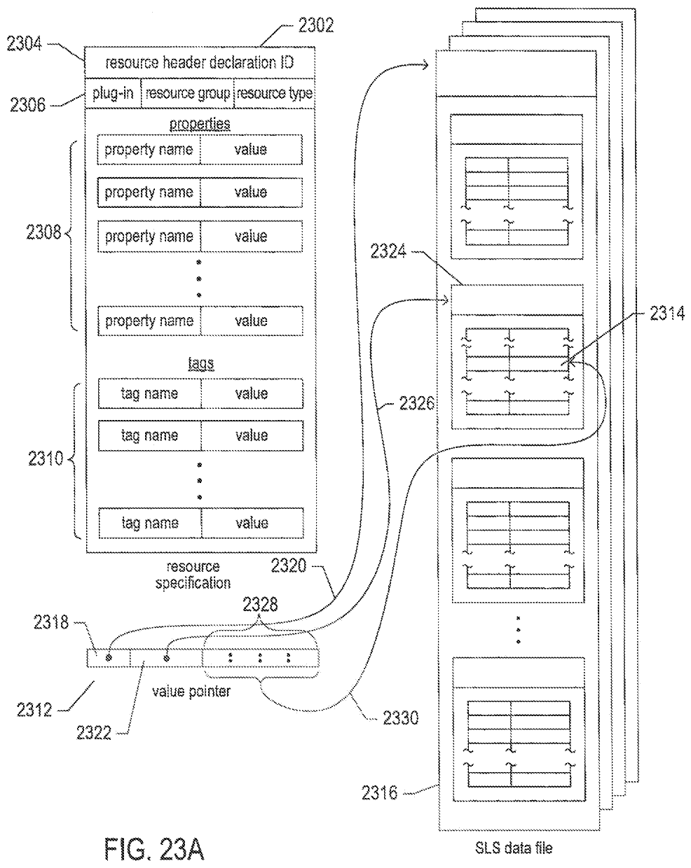

FIG. 22 illustrates a first step in the onboarding process introduced in the preceding paragraph. Upon receiving the onboard request or command, including authorization and authentication information needed to connect to the management interface associated with the cloud provider and/or cloud-computing facility currently hosting the already deployed and configured cloud infrastructure 2202, the Idem service executes an Idem describe command to generate raw SLS data 2204 that describes the already deployed and configured cloud infrastructure. The Idem service then allocates an in-memory data structure 2206 into which the information contained in the raw SLS data is loaded. The in-memory data structure includes general information regarding the already deployed and configured cloud infrastructure 2208 along with a set of resource descriptors 2210-2213, alternatively referred to as “resource data structures,” with ellipsis 2214 indicating that the set of resource descriptors shown in FIG. 22 may include many additional resource descriptors. The in-memory data structure thus contains the same information that is contained in the raw SLS data, but in a highly formatted data structure that allows for efficient computational processing. In addition, the in-memory data structure closely parallels the content and formatting of an SLS data filc.

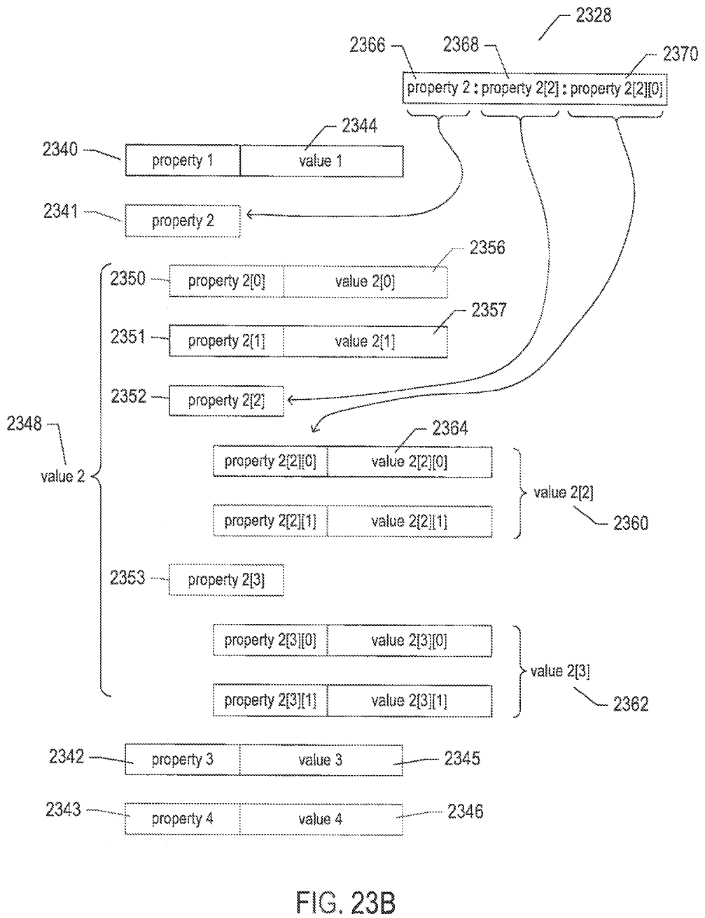

FIGS. 23A-B illustrate the concept of pointers to properties and tags in the in-memory data structure discussed above with reference to FIG. 22 and in SLS data files that together comprise a parameterized cloud template. FIG. 23A shows a resource descriptor 2302 within the above-discussed in-memory data structure, which also represents a resource specification in an SLS data file. The resource descriptor or resource specification includes a resource header declaration ID 2304 (1808 in FIG. 18A), referred to as a “state name” in the example SLS state file discussed in FIG. 18A, a plug-in/resource-group/resource-type tuple 2306 (for example, the plug-in/resource-group/resource-type tuple in directive 1810 in FIG. 18A), a list of property-name/property-value pairs 2308 (1812 in FIG. 18A), and a list of tag-name/tag-value pairs 2310 (1814 in FIG. 18A). In the following discussion, properties and tags are generally referred to as “attributes” and property and tag values are referred to as “attribute values,” since the distinction between properties and tags is not particularly relevant to the currently discussed methods and systems.

It is convenient to computationally generate a pointer, or reference, to a particular attribute in the in-memory data structure and in SLS data files. Such references may be used in argument bindings, for example, to refer to an attribute value. FIG. 23A shows the structure of an attribute pointer 2312 that points, or refers, to a particular attribute value 2314 in an SLS data file 2316. An attribute pointer can be, of course, used as a reference to either the attribute-name or attribute-value portion of an attribute. A first portion of the attribute pointer 2318 is a reference to the SLS data file 2316 or to an in-memory data structure, as indicated by curved arrow 2320. A second portion 2322 of the attribute pointer is a reference to the resource specification or descriptor 2324 that contains the attribute value 2314, as indicated by curved arrow 2326. A final portion of the attribute pointer 2328 is a reference to the attribute, including the attribute value field 2314, in the context of the resource specification or descriptor 2324 that contains the attribute value, as indicated by curved arrow 2330.

FIG. 23B illustrates the contents of the final portion 2328 of the attribute pointer 2312 shown in FIG. 23A. The attributes within a resource specification or descriptor may be hierarchically structured. FIG. 23B shows an example hierarchical structure of attributes. There are four highest-level attributes 2340-2343. Three of the highest-level attributes, attribute 1 (2340), attribute 3 (2342), and attribute 4 (2343), have simple values 2344-2346. However, attribute 2 (2341) has a complex value 2348 that includes four second-level attributes 2350-2353. Second-level attributes 2350 and 2351 both have simple values 2356-2357. However, second-level attributes 2352 and 2353 both have complex values consisting of a pair of third-level attributes 2360 and 2362. The final portion of the attribute pointer 2328 comprises a list of colon-separated subfields containing references to a first-level, second-level, and third-level attribute, with the third-level attribute referenced by the attribute pointer 2312 as a whole. A first subfield 2366 of the final portion of the attribute pointer references the first-level attribute 2341 in which value 2364 is contained. A second subfield 2368 of the final portion of the attribute pointer includes a reference to a second-level attribute 2352 in which value 2364 is contained. A third subfield 2370 of the final portion of the attribute pointer contains a reference to the third-level attribute 2364. Of course, the final portion of an attribute pointer contains only a sufficient number of colon-separated subfields to identify a particular attribute value, and may include a single subfield when the referenced value is that of a first-level attribute.

Different combinations of portions of the attribute pointer can be used as references to an in-memory data structure, an SLS data file, or a resource specification or descriptor. The first portion 2318 of an attribute pointer refers to either a specific SLS data file or to an in-memory data structure storing the contents of raw SLS data generated by execution of an Idem describe command. A combination of the first and second portions of an attribute pointer can be used as a reference to a particular resource descriptor or specification.

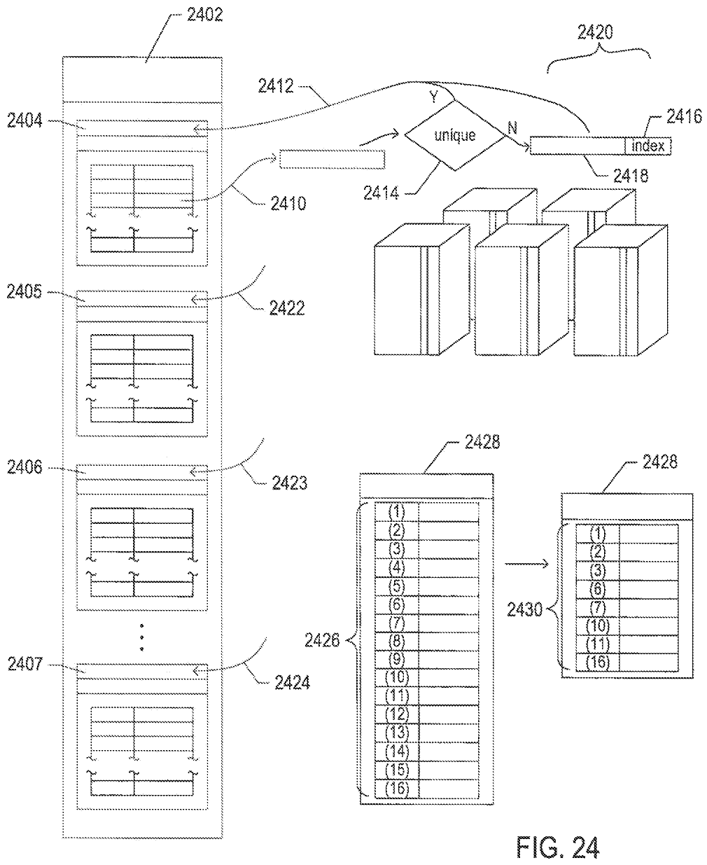

FIG. 24 illustrates a second step and a third step of the onboarding process that follow the first step, discussed above with reference to FIG. 22, in which raw SLS data is loaded into the in-memory data structure 2402. In the second step, the resource header declaration IDs 2404-2407 in the resource descriptors of the in-memory data structure are replaced with user-friendly resource header declaration IDs. User-friendly resource header declaration IDs are resource header declaration IDs with readily understandable natural-language meanings. The resource header declaration IDs returned in the raw SLS data by execution of the describe command are generally alphanumeric resource identifiers, or include alphanumeric resource identifiers, generated by the cloud provider or a non-Idem management interface for the deployed resources. In the second step of the onboarding process, the Idem service extracts one or more attribute values from a resource descriptor, represented by arrow 2410, and uses them to produce a user-friendly resource header declaration ID that is then copied into the resource descriptor, as indicated by arrow 2412. Such attribute values may include, for example, natural-language resource names. When the initially generated user-friendly resource header declaration ID is unique with respect to all of the user-friendly resource header declaration IDs so far generated by the onboarding process, as determined in conditional step 2414, the initially generated user-friendly resource header declaration ID is copied into the resource-header-declaration-ID field of the resource descriptor. Otherwise, an index 2416 is appended or prepended to the initially generated user-friendly resource header declaration ID 2418 to produce a unique user-friendly resource header declaration ID 2420, which is then copied into the resource-header-declaration-ID field of the resource descriptor. The second step of the onboarding process replaces the cloud-provider-generated resource header declaration IDs with user-friendly resource header declaration IDs, as indicated by arrows 2412 and 2422-2424. In a third step of the onboarding process, the attributes in each resource descriptor, such as the attributes 2426 in resource descriptor 2428, are evaluated for inclusion in the parameterized cloud template. Only those attributes that are needed to specify and configure resources during execution of an Idem state command are retained. Thus, in the example shown in FIG. 24, only a subset of the attributes 2430 remain in resource descriptor 2428 following the third step of the onboarding process, which attributes from the resource descriptors in the in-memory data structure 2402.

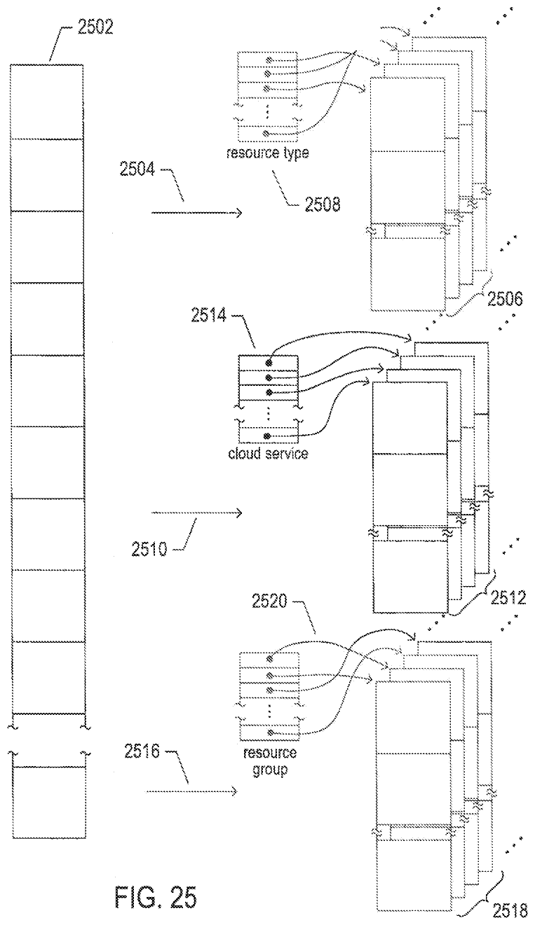

FIG. 25 illustrates a fourth step in the onboarding process. In the fourth step, the contents of the in-memory data structure 2502 are output to a set of SLS data files. The fourth step can be carried out according to one of a number of different grouping options. A first grouping option, represented by arrow 2504, partitions the resource descriptors in the in-memory data structure 2502 by resource type, as encoded in the plug-in/resource-group/resource-type tuple (2306 in FIG. 23A and 1810 in FIG. 18A). The resource descriptors for each different type of resource are used to generate resource specifications included in a particular SLS data file which, together with other SLS data files, comprises a parameterized cloud template. In FIG. 25, the set of SLS data files 2506 that together comprise a parameterized cloud template are shown indexed by resource type 2508, with each SLS data file corresponding to a different resource type. In many implementations, this is the default option for generating a parameterized cloud template from the contents of the in-memory data structure. A second grouping option is represented by arrow 2510. This option partitions the resource descriptors according to the cloud service with which they are associated. For example, an online retail website may include a set of front-end servers, middle-tier servers that provide multiple middle-tier services, and back-end servers that provide multiple back-end services. In this case, resource specifications for virtual machines that implement the front-end servers may be placed into a first SLS data file, resource specifications for virtual machines that implement a first service provided by certain of the middle-tier servers may be placed into a second SLS data file, and so forth. The assignment of resources to cloud services is made using information contained in the resource descriptors of the in-memory data structure. FIG. 25 shows the SLS data files 2512 produced by the second grouping option indexed by cloud service 2514. A third grouping option is represented by arrow 2516. This option partitions the resource descriptors according to the resource groups to which they belong. Resource groups may be defined by the value in the resource-group field of the plug-in/resource-group/resource-type tuple (2306 in FIG. 23A and 1810 in FIG. 18A) that characterizes a resource. Resources may alternatively be hierarchically grouped via attribute-value references to other resources. The root-level resources in such hierarchies define resource groups. Each SLS data file contains resource specifications for all of the resources within a resource group, defined by the resource-group field of the plug-in/resource-group/resource-type tuples in resource descriptors or by hierarchies of attribute-value references. FIG. 25 shows the SLS data files 2518 produced by the third grouping option indexed by resource group 2520.

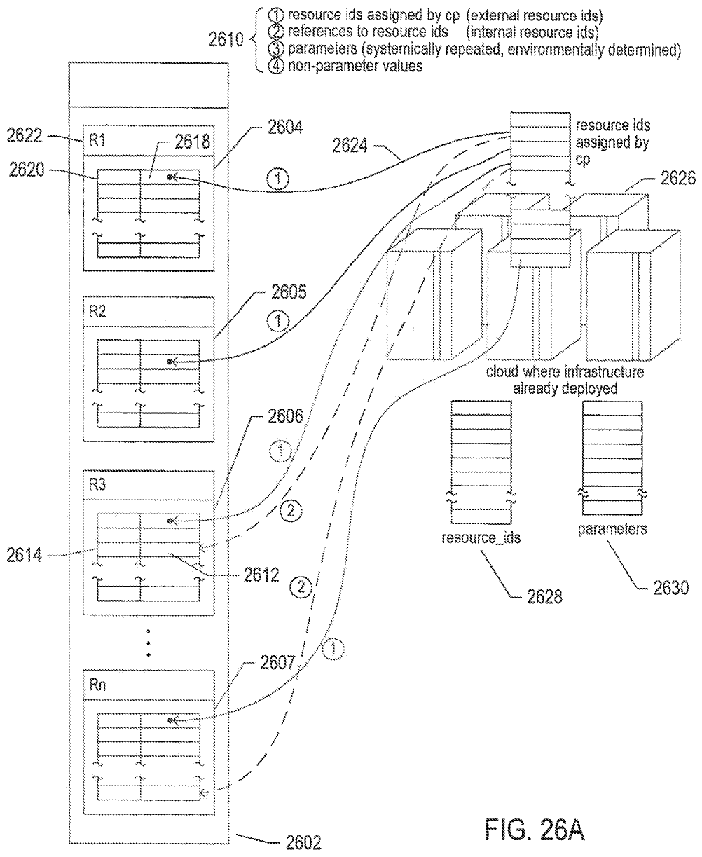

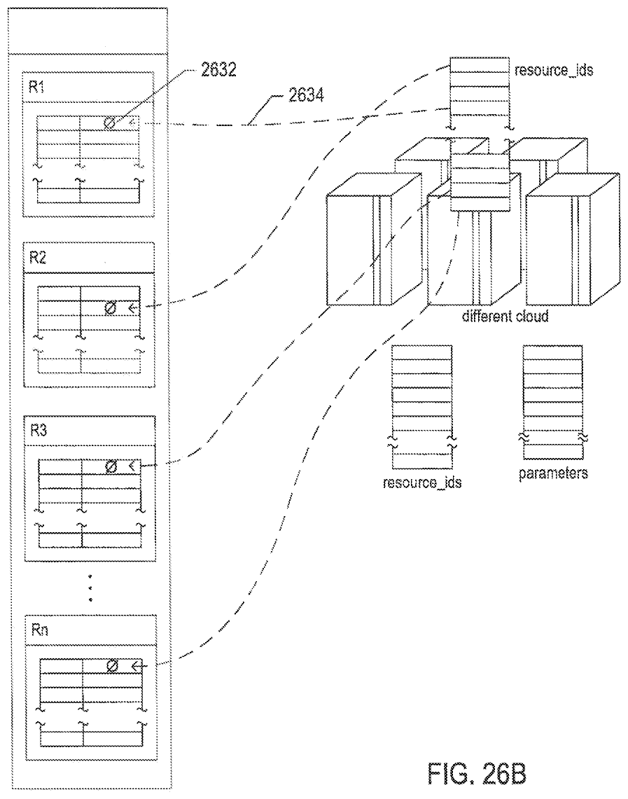

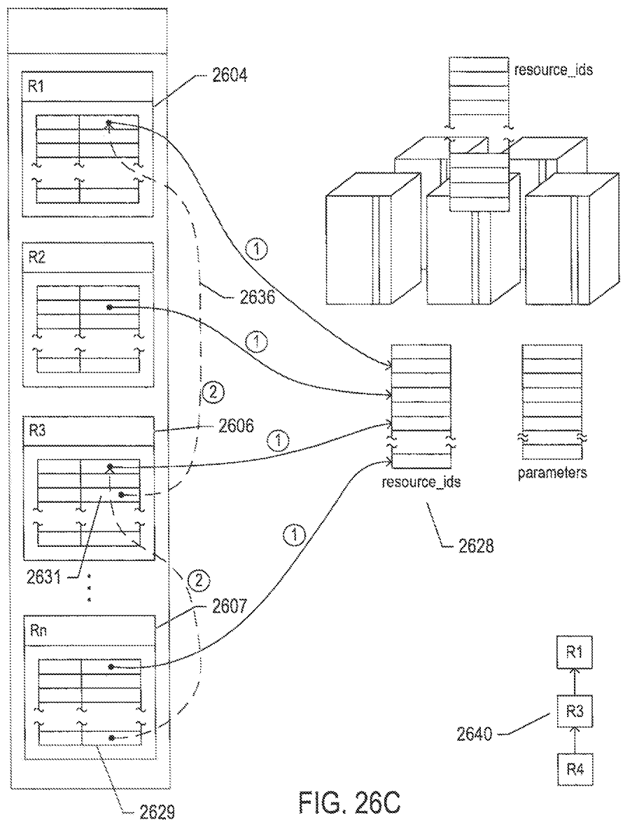

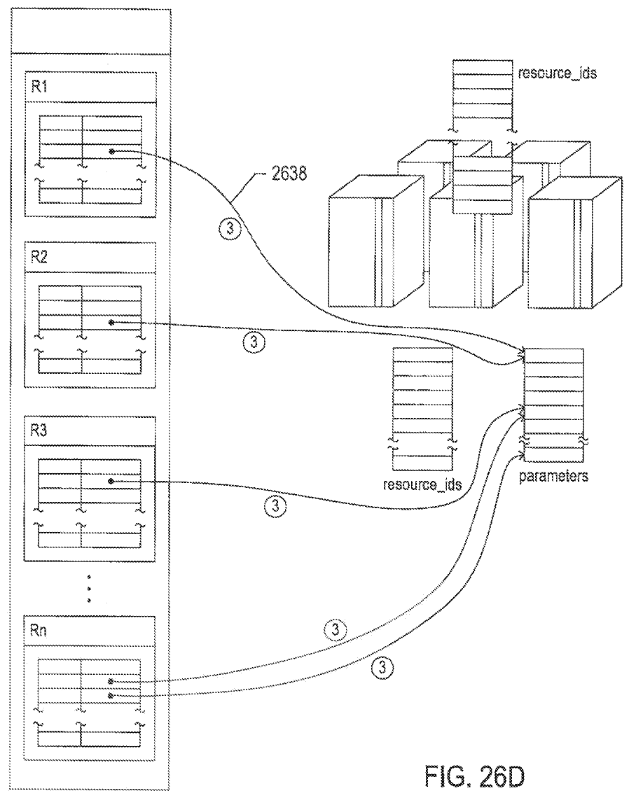

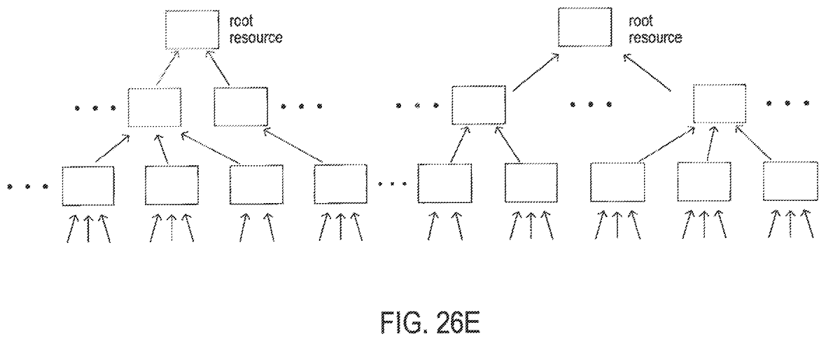

FIGS. 26A-E illustrate various types of attribute values. FIG. 26A shows resource specifications 2604-2607 within an SLS data file 2602 that contains data input from the in-memory data structure following the above-described fourth step of the onboarding process. Four different types of attribute values 2610 are shown at the top of FIG. 26A, with each attribute-value type associated with a circled numerical label. The first type of attribute value is a cloud-provider-generated resource id included within the resource descriptor for the resource identified by the resource id. Each resource descriptor in the SLS data file 2602 shown in FIG. 26A includes a cloud-provider-generated resource id that names or identifies the resource. An attribute value of the first type, even though an alphanumeric resource id, is essentially an external reference to a resource id and is referred to as an “external resource-id reference,” below, and is replaced by a resource function call, as further discussed below. A second type of attribute value is a resource id contained in an attribute-value field of a resource descriptor that acts as a reference to a resource id that names or identifies a resource in the same or another SLS data file. An attribute value of the second type is essentially an internal reference to a resource id and is referred to as an “internal resource-id reference” below. One example of an internal resource-id reference is the resource id contained in the value field 2612 of attribute 2614 in resource descriptor 2616. This resource id is the same as the resource id contained in the value field 2618 of attribute 2620 in resource descriptor 2622. Initially, as indicated by curved arrows, such as curved arrow 2624, the attribute values of the first and second types, referred to as external and internal resource-id references, are the alphanumeric resource ids assigned to the resources by the cloud provider 2626 containing the already deployed and configured infrastructure from which the data in the in-memory data structure was obtained via the Idem describe command. In FIG. 26A, solid curved arrows labeled with circled “1” symbols show the cloud-provider sources of attributes containing external resource-id references and dashed curved arrows labeled with circled “2” symbols show the cloud-provider sources of attributes containing internal resource-id references. FIG. 26A also shows a resource_ids data structure 2628 and a parameters data structure 2630. These two data structures are generated along with the one or more SLS files data files in the above-described fourth step of the onboarding process.

When the SLS data files are used as a cloud template for deploying equivalent infrastructure to a new cloud-computing facility/cloud provider (2114 in FIG. 21), the external resource-id references obtained via the Idem describe command from the cloud-computing facility/cloud provider containing the already deployed and configured infrastructure are not valid for the new cloud-computing facility/cloud provider. In this case, as indicated in FIG. 26B, the external resource-id references are removed, as indicated by the empty-set symbols, such as empty-set symbol 2632. Subsequently, as indicated by dashed arrows, such as dashed arrow 2634, following execution of a first Idem state command using the new cloud template, these blank attribute values are logically replaced with cloud-provider-generated resource ids used in the new cloud-computing facility. In the case that the SLS data files are used as a cloud template for the cloud-computing facility/cloud provider from which the initial external resource-id references are obtained via the Idem describe command (2112 in FIG. 21) and in the case that the SLS data files are used as a cloud template for deploying equivalent infrastructure to a new cloud-computing facility/cloud provider and the blank attribute values have been logically replaced by new resource ids, as discussed above, the new resource ids are stored in the resource_ids data structure 2628 and the attribute values containing external resource-id references in the SLS data files are replaced with resource function calls that act as references to the resource ids stored in the resource_ids data structure 2628, as shown in FIG. 18C. The internal resource-id references are replaced by argument bindings, discussed above with reference to 1828 in FIG. 18C, which are referred to as “resource-id bindings” in this discussion. The resource-id bindings are shown by dashed arrows, such as dashed arrow 2636 in FIG. 26C.

FIG. 26D illustrates parameter value, a third type of attribute value. Parameter values are attribute values that are environmentally determined. In general, parameter values occur multiple times in a parameterized cloud template. Examples of parameter values include the local virtual IP address or addresses associated with a virtual machine that may be encoded as one or more attribute values in the resource descriptor for the virtual machine. These local virtual IP addresses are assigned by the cloud provider, and are thus environmentally determined. The various different parameter values are contained in the parameters data structure 2630. Curved arrows, such as curved arrow 2638, map parameter values contained in resource-descriptor attribute values to the same parameter values contained in the parameters data structure or file. The attribute values containing parameter values are replaced with parameter function calls that act as references to the parameter values stored in the parameters data structure 2628. Finally, the fourth type of attribute values are the remaining attribute values that do not constitute either resource ids or parameter values. These attribute values generally specify desired characteristics of a resource.

Internal resource-id references may encode the resource hierarchies discussed above with reference to FIG. 25. In the example shown in FIG. 26D, the resource specification 2607 for resource Rn includes an internal resource-id reference 2629 that references resource R3 specified by the resource specification 2606. The resource specification for resource R3, in turn, includes an internal resource-id reference 2631 that references resource RI specified by the resource specification 2604. In this example, the internal resource-id references encode a simple resource hierarchy 2640 in which resource RI is the root resource. Of course, the same hierarchy could alternatively be encoded by internal resource-id references that reference resource Rn from resource R3 and that reference resource R3 from resource RI. More complex examples of resource hierarchies are shown in FIG. 26E. Thus, internal resource-id references and may encode resource hierarchies that define resource groups. Alternatively, as discussed above, resource groups may instead be defined by the resource-group field of the plug-in/resource-group/resource-type tuples in resource descriptors.

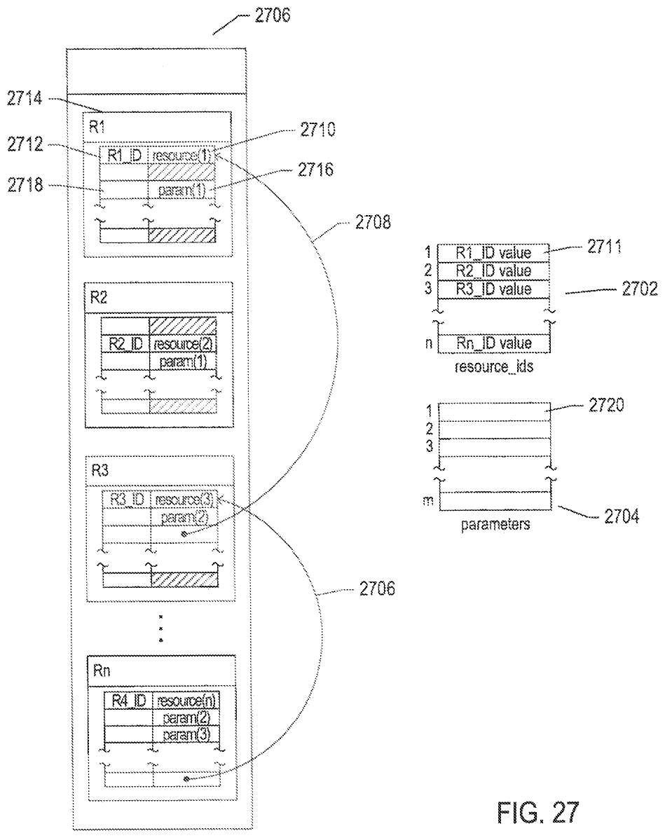

FIG. 27 illustrates fifth and six steps of the onboarding process. In the fifth step, the set of unique resource-id attribute values that identify resources in the cloud infrastructure specified by a parameterized cloud template are collected and stored in a resource_ids file 2702 and the unique parameter values included in the value fields of attributes are collected and stored in a parameters file 2704. In each of the SLS data files that together comprise a parameterized cloud template, such as an SLS data file 2706, internal resource-id references, discussed in the preceding paragraph, are replaced by resource-id bindings. These resource-id bindings are represented by curved arrows 2706 and 2708 in FIG. 27. The external resource-id references are replaced by resource function calls that essentially bind the attribute values of the first type to resource ids in the resource_ids file 2702, such as the resource function call in value field 2710 of attribute 2712 in resource specification 2714 that returns resource id 2711. Similarly, the value fields containing parameter values are modified to contain calls to a parameter function that essentially bind these value fields to parameters in the parameters file 2704. For example, value field 2716 of attribute 2718 in resource specification 2714 contains a parameter function call that returns the parameter value 2720 in parameters file 2704.

By removing resource ids and parameter values from the parameterized cloud template, the parameterized cloud template is transformed into a multi-purpose cloud template that can be used both for transitioning already deployed and configured cloud infrastructure to Idem-service management (2112 in FIG. 21) and for deploying new, equivalent cloud infrastructure in a new cloud-computing system (2114 in FIG. 21). In the former case, the resource ids in the resource_ids file are those initially included in the in-memory data structure and remain valid following transition of management to the Idem service, and the parameter values in the parameters file are similarly valid. In the latter case, once the new, equivalent cloud infrastructure has been initially deployed, new resource ids and parameter values for inclusion in the resource_ids file and parameters file are obtained using the Idem describe command. In both cases, resource-id bindings need not be changed, since they bind attribute value fields to other attribute value fields within the parameterized cloud template.

### Currently Disclosed Argument-Binding Methods and Systems

As discussed above, the Idem service and system carries out a process referred to as “argument binding” in order to replace attribute values and field values within resource descriptors that contain references to resource identifiers of other resource descriptors with a binding to the resource identifiers within the other resource descriptors. There are several reasons for employing argument binding. One reason, as discussed above, is to simplify the process of reuse specification-and-configuration files, used to deploy and configure cloud infrastructure within a first cloud-computing facility, for deploying and configuring a similar cloud infrastructure within a second cloud-computing facility. Rather than searching for all the various different field and attribute values that are resource identifiers and replacing them with new resource identifiers generated by the second cloud-computing facility, only the single occurrence of the resource identifier within the resource descriptor identified by the resource identifier needs to be changed. A second reason is that, during a deployment process specified by one or more specification-and-configuration files, argument bindings provide an indication of the dependencies among various different resource descriptors. These dependencies can be represented by an acyclic graph in which the resource types represented by child nodes of a parent node that represents a parent resource type represent dependencies of the child-node resource types on the parent resource type. In many cases, resources of the parent resource type need to be instantiated prior to instantiating the resources of the child resource types. Thus, argument binding provides a simple and efficient indication of the necessary order of instantiation of resources specified by specification-and-configuration files. The current application is directed to implementations of the argument-binding process that are incorporated into the Idem service and system. However, additional implementations of the argument-binding process to which the current document is directed can be used independently from other functionalities of the Idem service and system to provide for argument binding within both Idem and non-Idem specification-and-configuration files. The phrase “resource identifier” used in the following discussion refers to any of various different types of resource identifiers generated by cloud providers for instantiated resources. These resource identifiers may be encoded in alphanumeric character strings.

The currently disclosed methods and systems rely on argument-binding data furnished by cloud providers and by other argument-binding-data sources to facilitate the argument-binding process. FIGS. 28A-E illustrate the argument-binding data and the general process used to generate argument-binding data. As shown in FIG. 28A, a resource-dependency generator 2802 receives a large number of specification-and-configuration templates and files 2803 and uses them to generate one or more sets of argument-binding data 2804. The argument-binding data contains a set of parameter values 2805, a set of excluded attributes 2806, and an acyclic dependency graph 2807. As shown in FIG. 28B, the set of parameter values 2805 includes various alphanumeric character strings that are commonly used as parameter values in specification-and-configuration files and that do not refer to, or reference, resources via resource identifiers. The set of excluded attributes 2806 includes attributes within resource descriptors which do not contain values that refer to, or reference, resources via resource identifiers. The parameter values and excluded attributes are useful in avoiding attempted argument binding for values that are known not to refer to, or reference, resources via resource identifiers. The dependency graph 2807 includes one or more dependency-graph components 2808-2010. Each dependency-graph component is a connected acyclic graph that does not include connections to any of the other dependency-graph components. As indicated by the diagrammatic indication 2812, the nodes in a dependency-graph component 2813 and 2814 represent resource types such as virtual private clouds and subnets. The edges 2015 in the dependency-graph components are directed and represent the relation “is depended on by.” Thus, in the diagrammatic indication 2012, the resource type represented by node 2013 is depended on by the resource type represented by node 2814. This can be thought of as indicating that descriptors for the resource type 2814 include an argument binding that references a resource identifier in a descriptor for the resource type 2813. Each dependency-graph component therefore represents a set of dependency relationships between the resource descriptors of a number of different resource types.

In general, the argument-binding data used in the argument-binding process is obtained from analysis of the dependencies between different types of resources in a large set of specification-and-configuration files (2803 in FIG. 28A). This information includes explicit declarations and argument bindings. As shown in FIG. 28C, definition files provided by cloud providers, such as definition file 2820, may include explicit resource-type dependency-relation declarations, such as the TREQ resource-dependency declaration 2022. In this example, the definition file 2820 provides a definition for the NAT Gateway resource type and the TREQ resource-dependency declaration 2022 indicates that a resource of the type NAT Gateway depends on prior instantiation of a subnet. The TREQ resource-dependency declaration 2022 is represented in a dependency-graph component as an edge between nodes representing the NAT Gateway resource type and the subnet resource type 2824. As shown in FIG. 28D, a portion of a specification-and-configuration file 2026 is processed to remove Jinja control structures, with the processed portion of the specification-and-configuration file 2028 shown in the lower portion of FIG. 20D. In this case, a Jinja for-loop specifying two subnet instances is removed and replaced by explicit specifications of the two subnet instances. This type of processing is carried out by the resource-dependency generator discussed above with reference to FIG. 28A. The two subnet specifications 2830 and 2832 include argument bindings 2834 and 2836, respectively, which bind the values of the attributes “vpx_id” to the resource_id contained in a subnet resource descriptor. These two argument bindings provide evidence for the dependency relationship represented by dependency-graph-component edge 2838. Thus, resource-dependency declarations and argument bindings discovered in the analysis of many different specification-and-configuration files provide a basis for developing the acyclic dependency graph included in argument-binding data.

FIG. 28E illustrates resource-type encodings and resource descriptors. As discussed above with reference to FIG. 23A, in certain implementations, the resource type is encoded in a resource-type field 2840 within a cloud-provider/service/resource_type tuple 2306 within a resource descriptor 2302 which also contains a resource ID 2304 for the resource. The entire tuple 2842 can be used as a resource-type specifier when a single set of argument-binding data 2844 is used for specification-and-configuration data files containing all of the various resource types within various services provided by multiple different cloud providers. On the other hand, the service and resource-type fields of a cloud-provider/service/resource_type tuple can be used as a resource-type specifier 2846 in the case that argument-binding data is provided by each cloud provider 2048 or in the case that resource types are unique across services provided by each cloud provider for processing cloud-provider-specific specification-and-configuration files. The resource-type field of a cloud-provider/service/resource_type tuple can be used as a resource-type specifier 2850 when resource types are unique across services provided by each cloud provider or when argument-binding data is provided for each service by each cloud provider 2852. In the following discussion, it is assumed that appropriate resource-type specifiers are used for the argument-binding data input to the argument-binding process for carrying out argument binding on a set of input specification-and-configuration files.

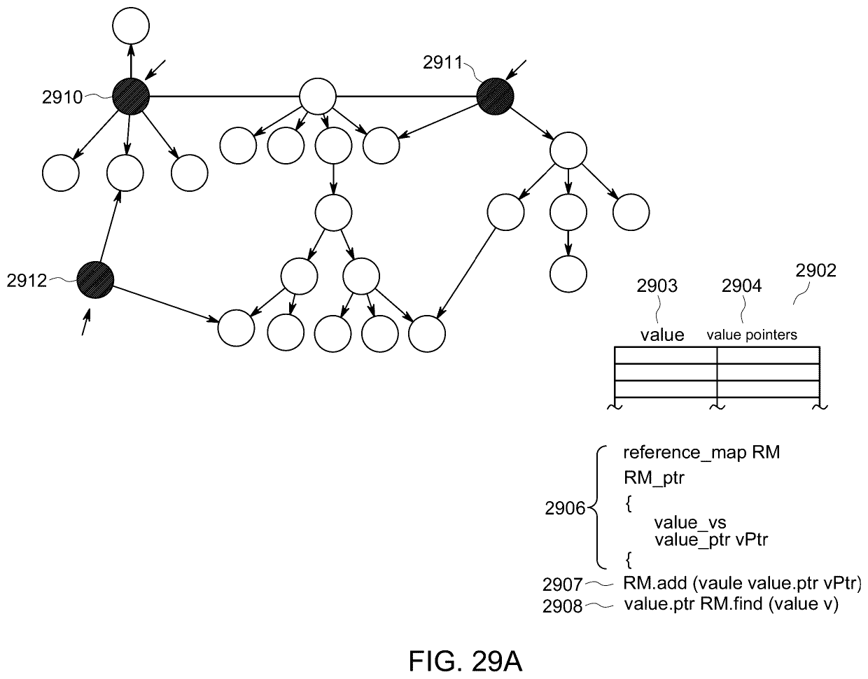

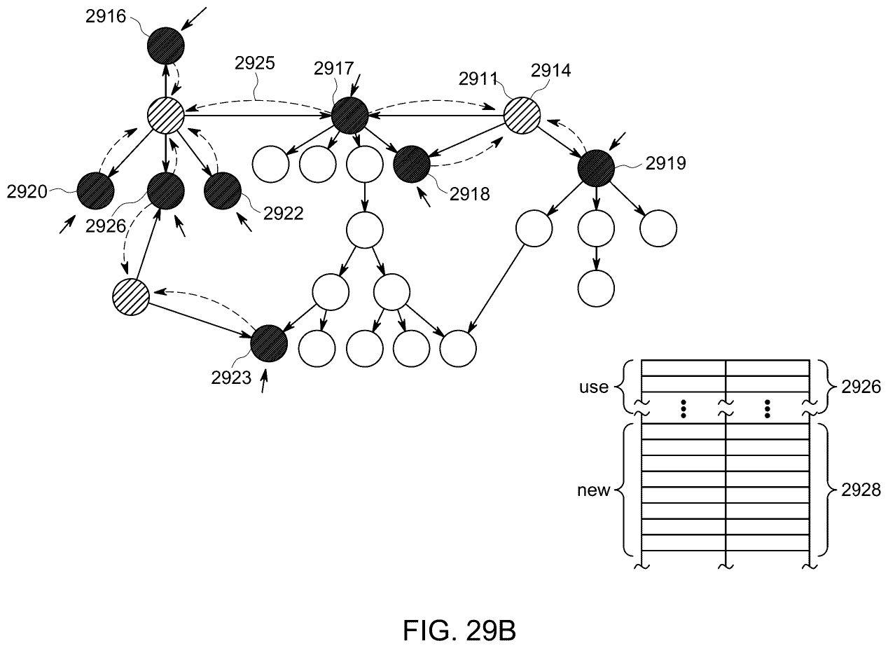

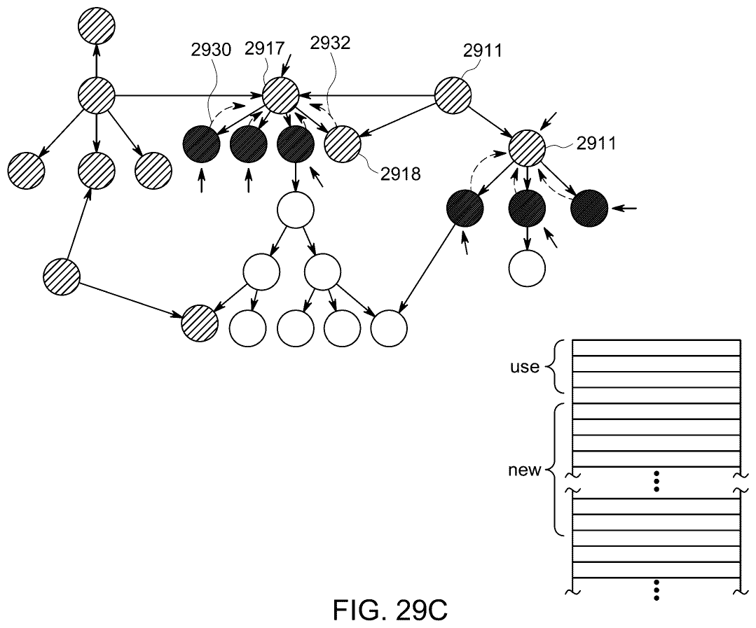

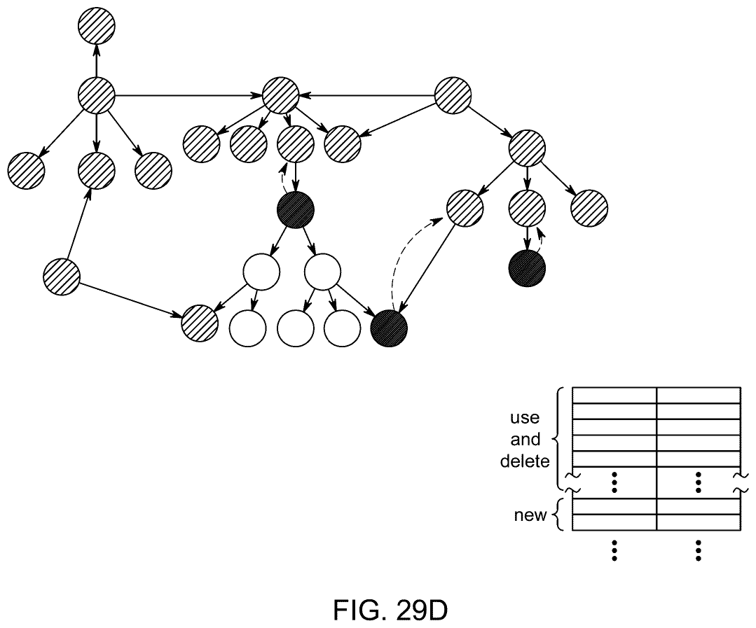

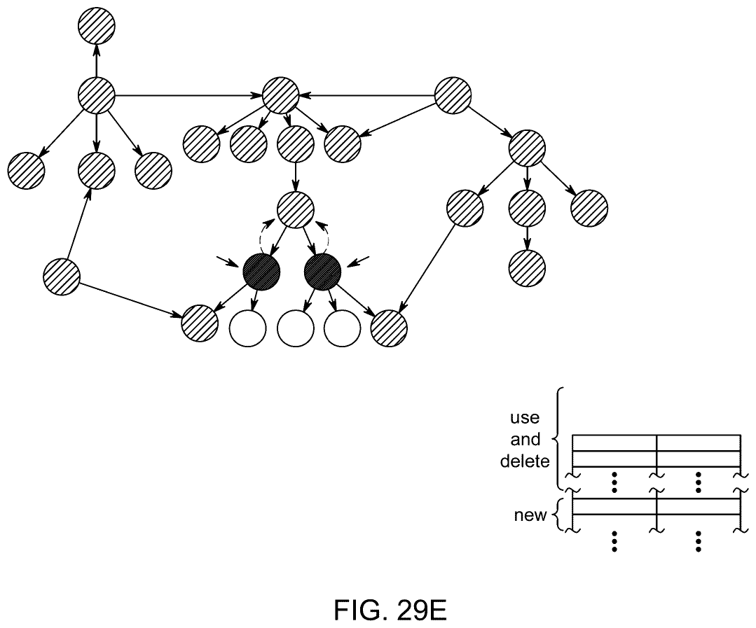

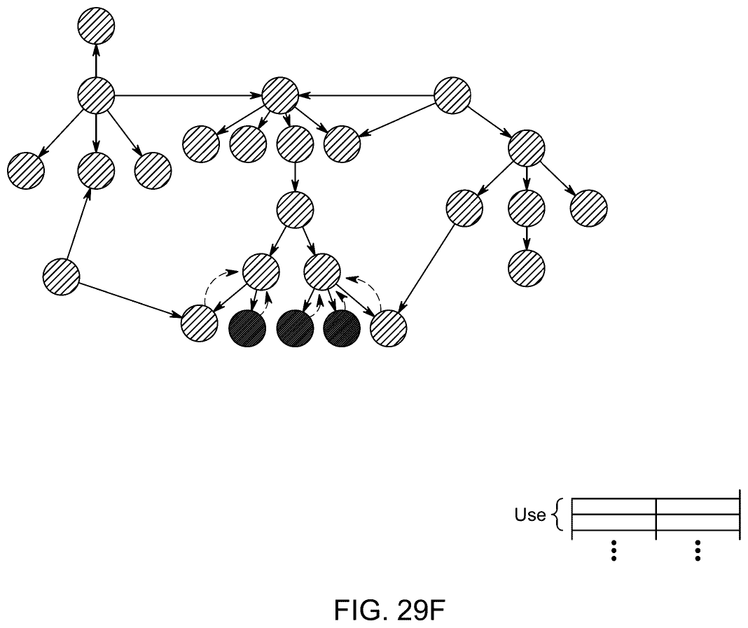

The currently disclosed argument-binding process is separately carried out for each dependency-graph component within the argument-binding data input to the argument-binding process. FIGS. 29A-F illustrate the currently disclosed argument-binding process with respect to an example dependency-graph component. FIG. 29A illustrates a first step in the argument-binding process. FIGS. 29B-F use the same illustration conventions as used in FIG. 29A. The argument-binding process uses a reference map 2902 that consists primarily of a two-column table that includes a first column 2903 containing field and attribute values extracted from resource descriptors and a second column 2904 containing the value pointers that reference the extracted values, with each entry representing a field or attribute value along with the value pointer to the field or attribute value. Pseudocode declarations for the reference map and each entry in the reference map 2906 are provided below the depiction of the reference map. The reference map is associated with two member functions: (1) add 2907, which adds an entry to the reference map; and (2) find 2908, which receives a value and returns a value pointer for the value, when the value/value-pointer pair is stored in the reference map, and otherwise returns a null value.

The initial step of the argument-binding process finds all of the nodes 2910-2912 within the dependency-graph component that are not linked to other nodes by incoming edges. In other words, these initially identified nodes represent root nodes of the acyclic dependency-graph component. The root nodes are considered in the initial step, and are therefore shaded and annotated with short arrows, in FIG. 29A, to emphasize the currently considered nodes. To avoid awkward language, the following discussion may use language such as “resource type A references resource type B” to mean that the resource descriptors of resource type A reference resource descriptors of resource type B. The reference IDs in the resource descriptors of the root resource types are added to the reference map as value/value-pointer pairs. A next set of nodes in the dependency-graph component, the nodes connected to the root nodes by directed edges, is also determined in the first step of the argument-binding process.

FIG. 29B illustrates a second step in the currently disclosed argument-binding process. The second step is repeated iteratively until all of the nodes in the dependency-graph component have been processed. The root nodes were processed in the initial step, and therefore are shown striped rather than shaded, such as the striping 2914 in node 2911. The next set of nodes 2916 selected in the initial step are now the currently-considered nodes, and are therefore shaded and annotated with short arrows in FIG. 29B. The second step includes two sub-steps. In the first sub-step, illustrated by dashed arrows, such as dashed arrow 2925, field and attribute values in the resource descriptors of the resource types represented by the currently considered nodes in the dependency-graph component that also occur in the reference map are replaced by argument bindings that incorporate the value pointers in the reference map associated with the field and attribute values. Then, in a second sub-step, the reference map is cleared and reference IDs identified in the resource descriptors of the resource types that correspond to the currently considered dependency-graph components are identified and added to the reference map. Thus, the portion of the reference map labeled “use” 2926 is used for argument binding and is then removed, and the reference IDs in the resource descriptors corresponding to the resource types of the currently considered dependency-graph nodes are added to the reference map so that the reference map now includes only the portion 2928 labeled “new” in FIG. 29B. The second sub-step is equivalent to the first step discussed above with reference to FIG. 29A. As in that first step, a next set of nodes is selected for consideration in a following iteration of the second step, with the next set of nodes comprising those nodes linked by directed arrows to the currently considered nodes.

FIG. 29C illustrates the second iteration of the second step of the argument-binding process. The current nodes considered in the first iteration of the second step, illustrated in FIG. 29B, are now striped rather than shaded, to indicate that they have been processed. Again, dashed arrows, such as dashed arrow 2930, represent the argument-binding sub-step. Note that node 2918, although already processed, also participates in the first subset of the second iteration of the second step, as indicated by dashed arrow 2932. This is because node 2918 depends from node 2917 in addition to node 2911, and the reference ID(s) contained in node 2917 were added to the reference map after processing of node 2918 in the first iteration of the second step. Thus, node 2918 is shown with crosshatching rather than stripes to indicate that it is currently participating in the first sub-step of the second iteration of the second step. FIGS. 29D-F illustrates third through fifth iterations of the second step using the same illustration conventions as used in FIGS. 29A-C. The argument-binding process completes when all nodes in the dependency-graph component have been processed.

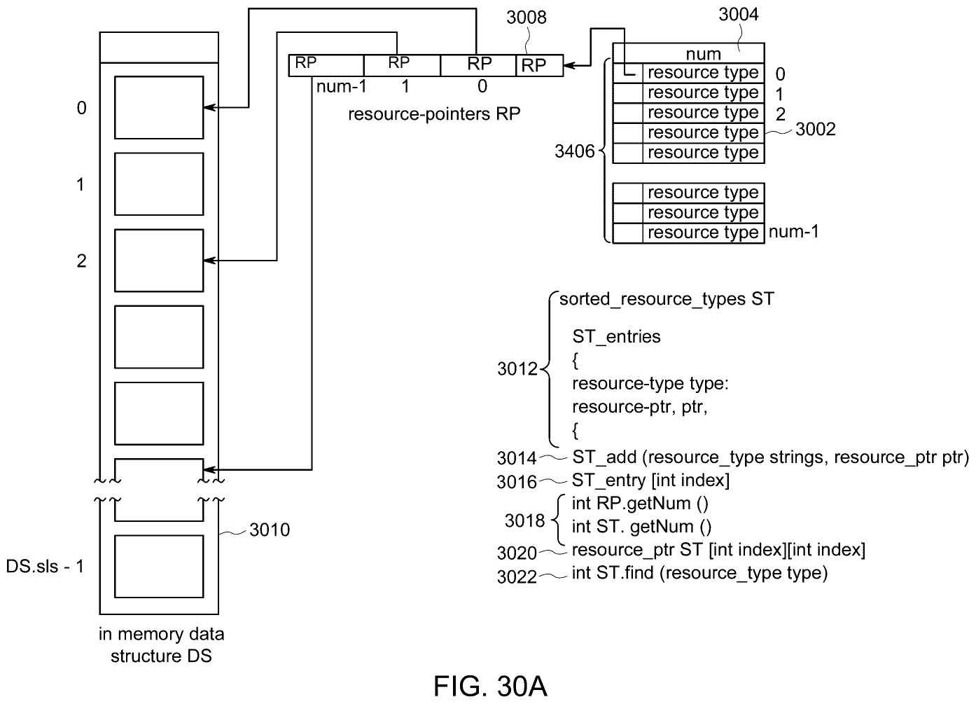

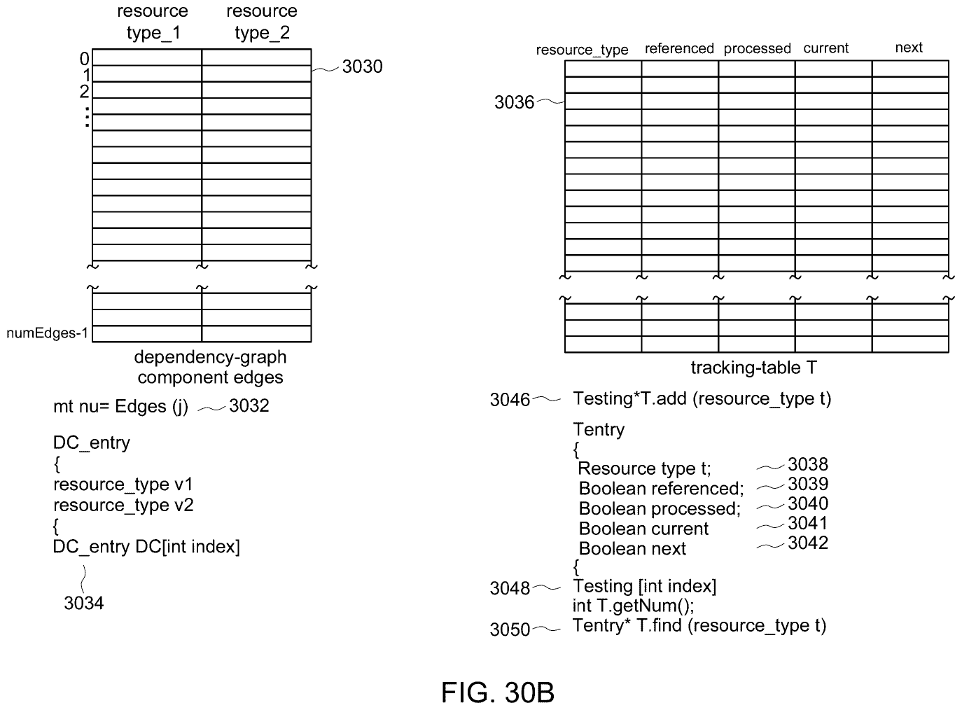

FIGS. 30A-B illustrate additional data structures used in an implementation of the currently disclosed argument-binding process. FIG. 30A illustrates the sorted_resource_types data structure ST. The ST 3002 includes a field num 3004 that indicates the number of resource types in the ST and a list 3406 of entries, each including a resource-type indication and a pointer to a list of resource-descriptor pointers 3008. In essence, the ST stores a mapping between resource types and lists of pointers to resource descriptors with common resource types, and thus represents a sorting of the resource descriptors into groups of resource descriptors each corresponding to a particular resource type. The currently disclosed implementation carries out argument binding within the above-discussed in-memory data structure DS 3010 into which the information contained in one or more input raw SLS data files are stored. However, in alternative implementations, the currently disclosed argument-binding process may be carried out on the SLS data files themselves, without constructing the above-discussed in-memory data structure. Pseudocode declarations for the ST and for ST entries 3012 are provided below the depiction of the ST. The ST is associated with a number of member functions: (1) add 3014, which adds a resource-descriptor pointer to the ST and, when the resource type of the resource descriptor is not already present in the ST, adds the resource type and a list of resource-descriptor pointers to the ST and then adds the resource-descriptor pointer to the list of resource-descriptor pointers; (2) an indexing operator 3016, allowing the ST to be treated as an array of ST entries; (3) two getNum member functions 3018 that return the number of resource-descriptor pointers in a list of resource-descriptor pointers and the number of entries in the ST; (4) a double indexing operator 3020 that allows the ST to be treated as a two-dimensional array; and (5) a find member function 3022 that returns the index of an ST entry corresponding to an input resource-descriptor type.

FIG. 30B illustrates two additional data structures. The edges data structure 3030 within a dependency-graph component includes entries that each contains a first resource type and a second resource type. Each entry in the edges data structure represents an edge in the dependency-graph component directed from the second resource type to the first resource type in the entry. A dependency-graph component also includes a member function numEdges 3032 that returns the number of edges in the dependency-graph component and an indexing operator 3034.

The tracking-table data structure T 3036 contains entries that include a resource_type field 3038, a referenced field 3039, a processed field 3040, a current field 3041, and a next field 3042. The resource_type field contains an indication of a resource type. The referenced field indicates whether or not the resource type is referenced by other resource types in the dependency-graph component. The processed field indicates whether or not the resource type has been processed during the argument-binding process. The current field indicates whether or not the resource type corresponds to one of the currently-considered nodes in the dependency-graph component and the next field indicates whether or not the resource type has been selected for consideration in a next iteration of the second step of the argument-binding process. The tracking-table T includes several member functions: (1) add 3046, which adds an entry to T for the specified resource type; (2) an indexing operator 3048 which allows T to be treated as an array of entries; (3) getNum, which returns a number of entries in T; and (4) find 3050, which returns a pointer to the Tentry that represents the input resource type or, when the input resource type is not represented by an entry in T, returns a null value.

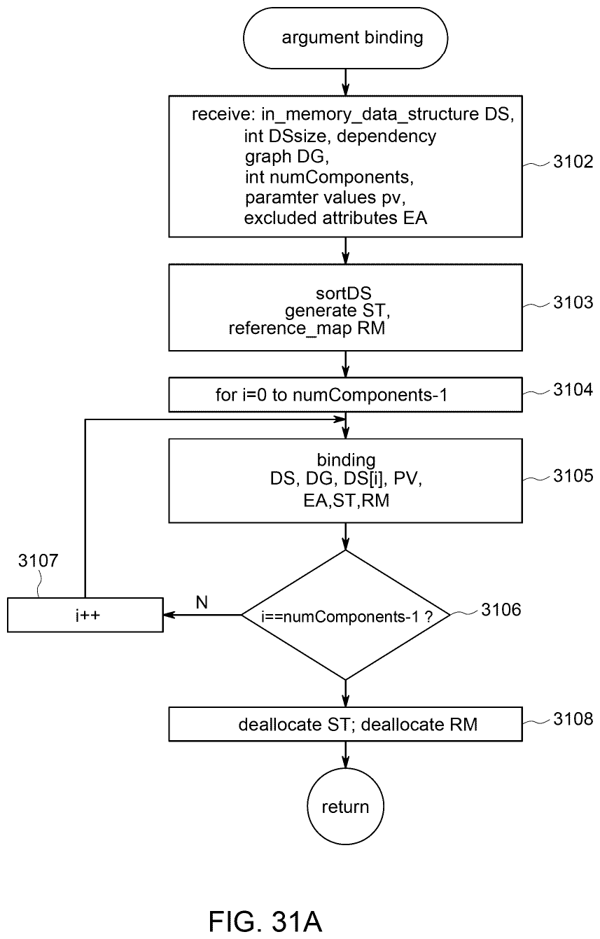

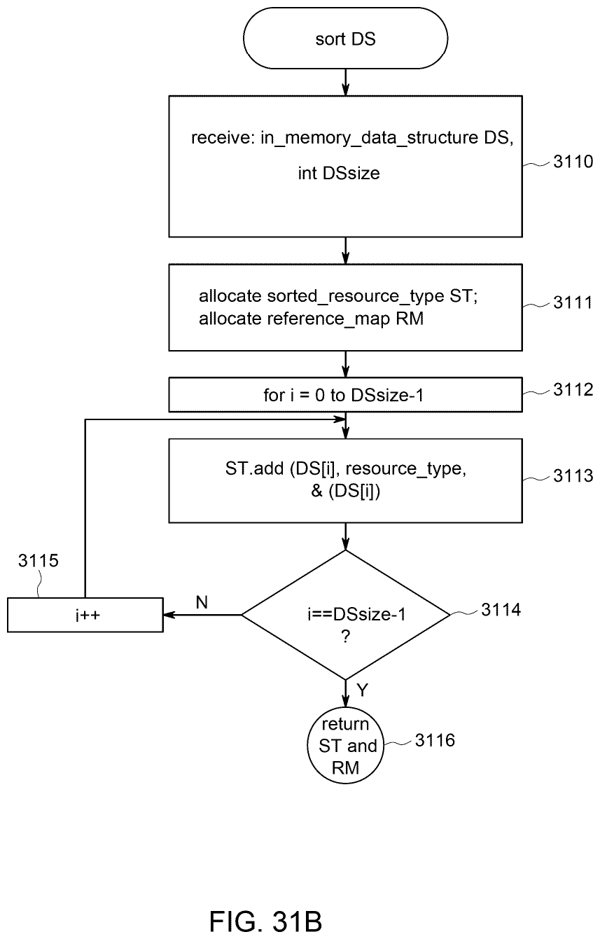

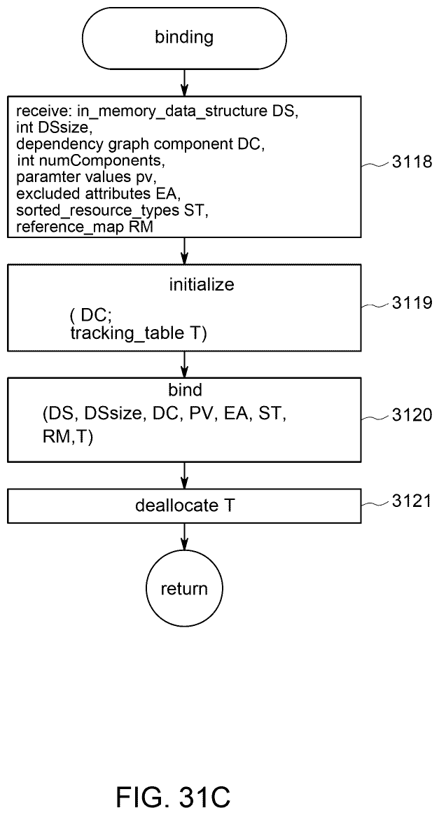

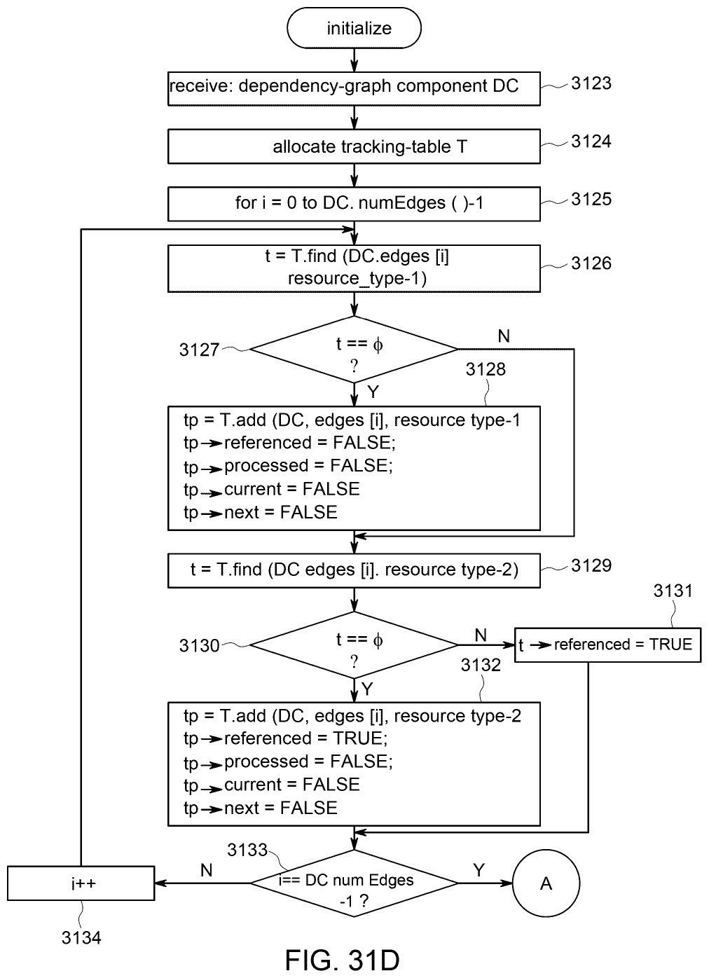

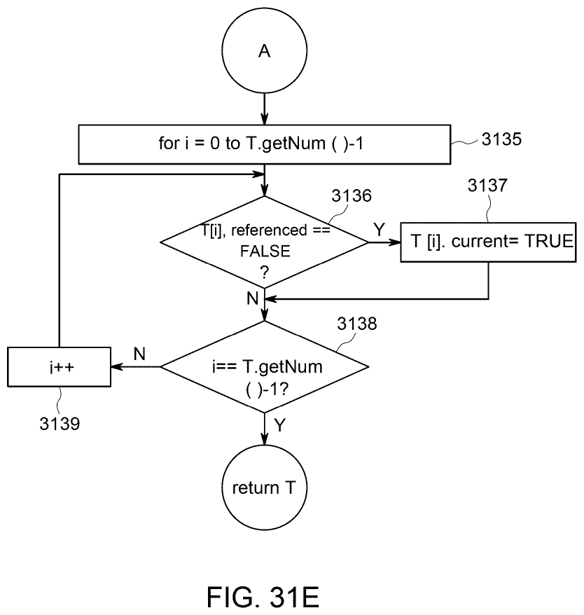

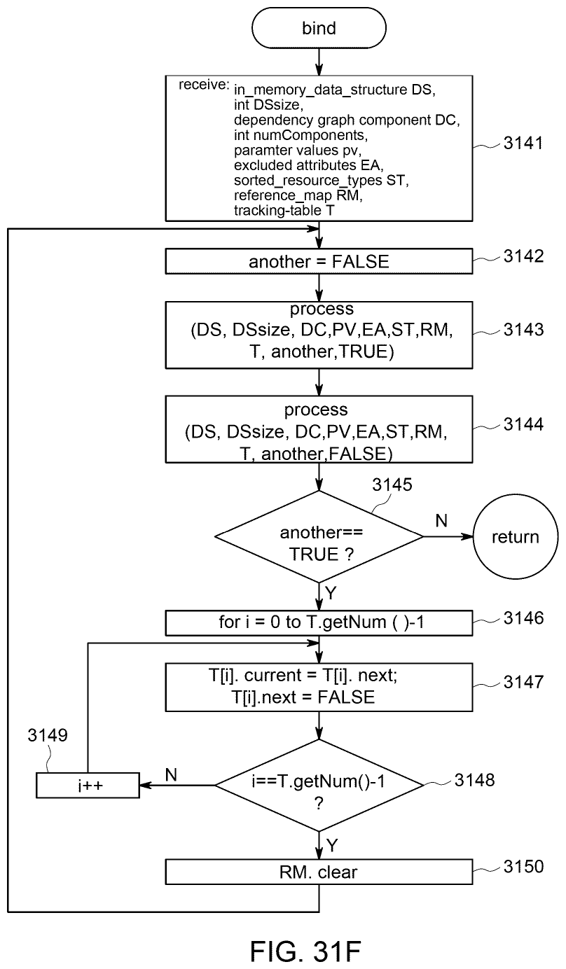

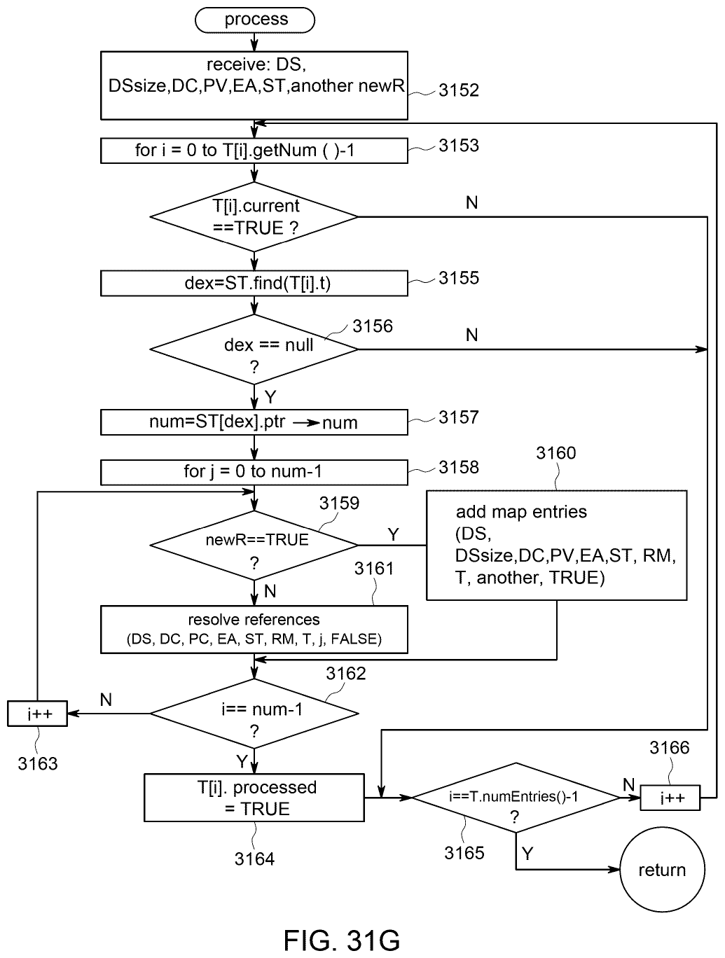

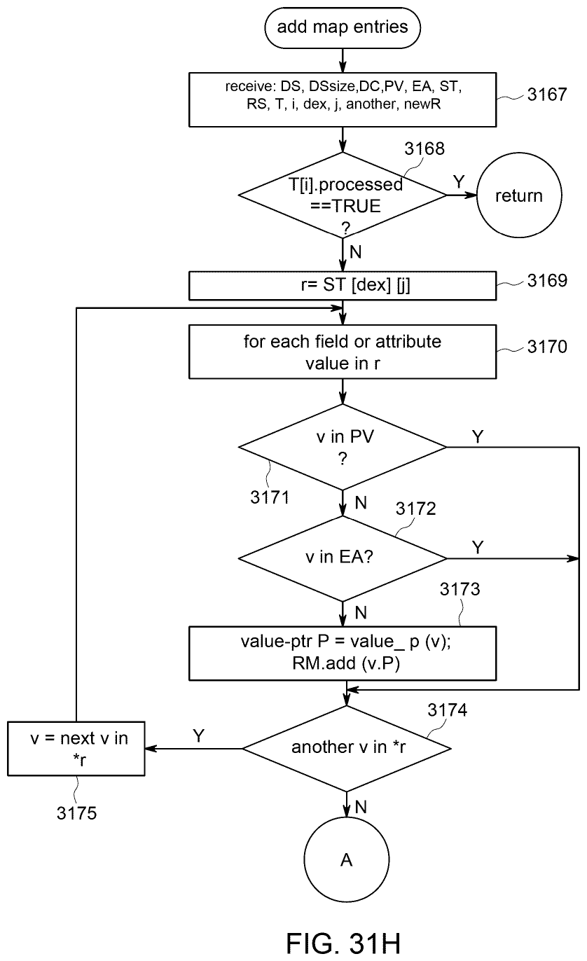

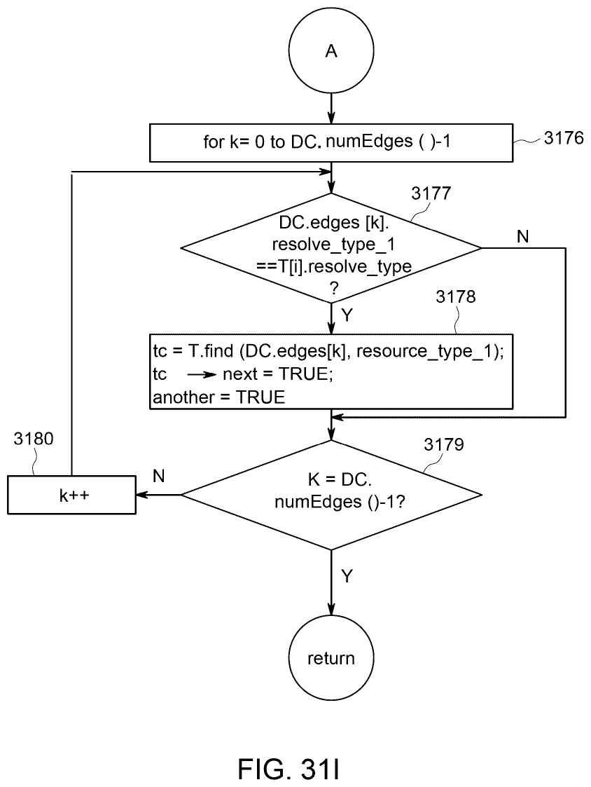

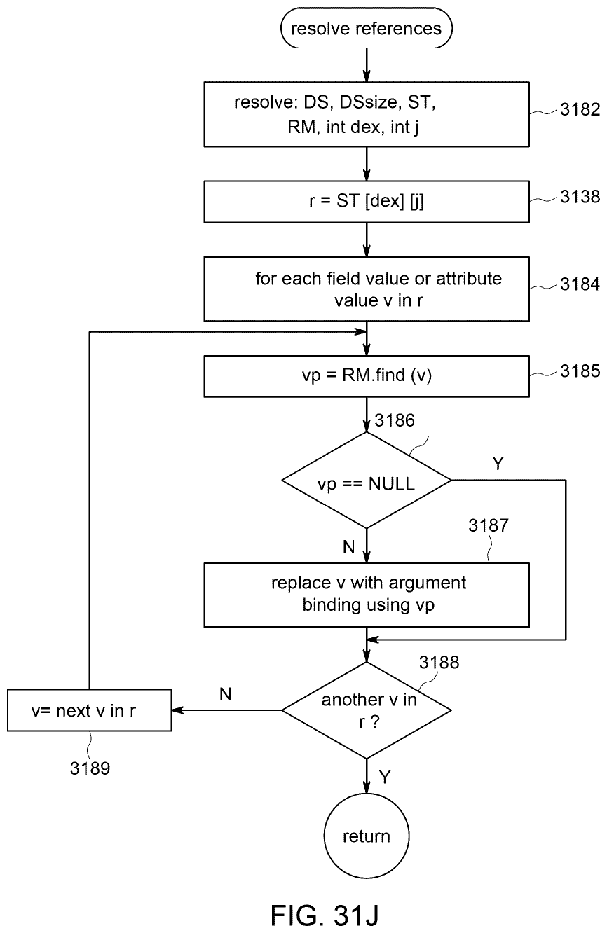

FIGS. 31A-J provide control-flow diagrams that illustrate an implementation of the currently disclosed argument-binding process. FIG. 31A provides a control-flow diagram for a routine “argument binding” that illustrates the argument-binding process. In step 3102, the routine “argument binding” receives an in-memory data structure DS, an indication of the number of resource descriptors DSsize in the in-memory data structure, a dependency graph DG included in argument-binding data, an indication of the number of components in the dependency graph numComponents, a set of parameter values PV included in the argument-binding data, and a set of excluded attributes EA, also included in the argument-binding data. All of the data-structure arguments are passed by reference while the integer arguments are passed by value. These same arguments are received by many of the routines discussed below, and are not again discussed in detail in the discussions of those routines. All of the data-structure arguments are discussed above with reference to FIGS. 28A-B, 29A, and 30A-B. In step 3103, the routine “argument binding” calls a routine “sortDS” to generate the above-discussed ST data structure that represents sorting of the resource descriptors in the in-memory data structure by resource type. The routine “sortDs” also generates the above-discussed reference-map RM data structure. Then, in the for-loop of steps 3104-3107, the routine “argument binding” repeatedly calls a routine “binding” to carry out the currently disclosed argument-binding process for each component of the dependency graph DG. Following completion of the for-loop of steps 3104-3107, the routine “argument binding” deallocates the ST and RM, in step 3108.

FIG. 31B provides a control-flow diagram for the routine “sortDS,” called in step 3103 of FIG. 31A. In step 3110, the routine “sortDS” receives DS and DSsize. In step 3111, the routine “sortDS” allocates the ST and RM data structures. Note that these data structures are variably sized, increasing in size as entries are added. In the for-loop of steps 3112-3115, the routine “sortDS” adds a pointer to each resource descriptor in DS to the ST data structure using the above-discussed add member function of the ST. Upon completion of the for-loop of steps 3112-3115, the resource descriptors in the DS have been grouped by resource type in the ST and the routine “sortDS” returns references to the ST and RM.

FIG. 31C provides a control-flow diagram for a routine “binding.” called in step 3103 of FIG. 31A. In step 3118, the routine “binding” receives the various references to data structures received by the routine “argument binding” in step 3102 as well as references to the ST and RM data structures, allocated by the above-discussed routine “sortDS.” In step 3119, the routine “binding” calls a routine “initialize” to create and initialize the tracking-table T. Then, in step 3120, the routine binding calls a routine “bind” to carry out argument binding with respect to the dependency-graph component DC. Finally, in step 3121, the routine “binding” deallocates the tracking-table T.

FIG. 31D provides a control-flow diagram for a routine “initialize,” called in step 3119 of FIG. 31C. In step 3123, the routine “initialize” receives the dependency-graph component DC. In step 3124, the routine “initialize” allocates a tracking-table T, discussed above. The tracking-table data structure is also a variably sized data structure that increases in size as entries are added. In the for-loop of steps 3125-3134, the routine “initialize” adds entries to the tracking-table T for each resource type in the dependency-graph component DC. To do so, the routine “initialize” considers each edge in DC. When the first resource type of the currently considered edge is not already present in the tracking-table T, as determined in step 3127, a new entry for the resource type is added to T, in step 3128. When the second resource type of the currently considered edge is already present in the tracking-table T, as determined in step 3130, the referenced field in the entry in T for the second resource type of the currently considered edge is set to TRUE, in step 3131, since it is referenced by the first resource type in the edge. Otherwise, a new entry is added to the tracking-table T for the second entry in the currently considered edge. Turning to FIG. 31E, in the for-loop of steps 3135-3139, the routine “initialize” sets the current field of the T entries for unreferenced resource types to TRUE, in step 3137, to select the dependency-graph-component nodes corresponding to these entries as the root nodes, as discussed above with reference to FIG. 29A.

FIG. 31F provides a control-flow diagram for a routine “bind,” called in step 3120 of FIG. 31C. In step 3141, the routine “bind” receives references to the various data structures received by the routine “binding” in step 3118 as well as a reference to the tracking-table T. In step 3142, the routine “bind” sets local Boolean variable another to FALSE. In steps 3143 and 3144, the routine “bind” calls a routine “process” to carry out the first step of the currently disclosed argument-binding process and the first and second substeps of the second step of the currently disclosed argument-binding process. When, as determined in step 3145, the local variable another has not been set to TRUE by the first call to the routine “process” in step 3143, the routine “bind” returns. The local variable another is set to TRUE when a next set of nodes has been selected for another iteration of the second step of the currently disclosed argument-binding process, as discussed above with reference to FIGS. 29A-F. Otherwise, in the for-loop of steps 3146-3149, the values in the field next in the tracking-table T entries are moved to the field current and the field next is set to FALSE, in step 3147, so that the next selected dependency-graph-component nodes become the current dependency-graph-component nodes for a next iteration of the second step of the currently disclosed argument-binding process, as also discussed above with reference to FIGS. 29A-F. Finally, in step 3150, the routine “bind” clears the reference map RM.

FIG. 31G provides a control-flow diagram for the routine “process,” called in steps 3143-3144 of FIG. 31F. In step 3152, the routine “process” receives references to the various data structures, a reference to the variable another, instantiated in the routine “bind,” and the Boolean argument newR that is set to TRUE for the first step and the first sub-step of the second step of the currently disclosed argument-binding process and that is set to FALSE for the second sub-step of the second step of the currently disclosed argument-binding process. In the for-loop of steps 3153-3166, the routine “process” considers each entry in the tracking-table T. When the current field of the currently considered entry of the tracking-table T does not contain the value TRUE, as determined in step 3154, control flows to step 3164 to consider another iteration of the for-loop of steps 3153-3166. In step 3155, the routine “process” calls the ST member function find to determine the index of the resource type corresponding to the currently considered T entry. When a null value is returned by ST member function find, as determined in step 3156, control flows to step 3164 to consider another iteration of the for-loop of steps 3153-3166. In step 3157, the routine “process” sets local variable num to the number of resource-descriptor references stored in the ST for the resource type corresponding to the currently considered entry in T. In the inner for-loop of steps 3158-3163, the routine “process” calls a routine “add map entries,” in step 3160, when Boolean argument newR contains TRUE, as determined in step 3159, and otherwise calls a routine “resolve references” in step 3161. In step 3164, the processed field for the currently considered tracking-table T entry is set to TRUE.

FIG. 31H provides a control-flow diagram for a routine “add map entries,” called in step 3160 of FIG. 31G. In step 3167, the routine “add map entries” receives references to the various data structures, a reference to the variable another, instantiated in the routine “bind.” an index i that specifies an entry in the tracking-table T and indices dex and j that specify a resource-descriptor pointer in the ST data structure. When the processed field in the entry in the tracking-table T indexed by i contains the value TRUE, as determined in step 3168, the routine “add map entries” returns, since the initial sub-step of the second step of the currently disclosed argument-binding process is not executed for already-processed dependency-graph-component nodes. Otherwise, in step 3169, local variable r is set to reference a resource descriptor of a resource type corresponding to currently considered nodes in the dependency-graph component. In the for-loop of steps 3170-3175, each field value or attribute value in the resource descriptor referenced by local variable r is considered. When the value is contained in the parameters-values set PV, as determined in step 3171, the current iteration of the for-loop of steps 3170-3175 is short-circuited, since the value is excluded from consideration. Similarly, when the value is an attribute value of an attribute that is contained in the excluded-attributes set EA, as determined in step 3172, the for-loop of steps 3170-3175 is short-circuited, since the attribute is excluded from consideration. Otherwise, in step 3173, the value is added to the reference map RM. Turning to FIG. 31I, the routine “add map entries,” in the for-loop of steps 3176-3180, selects a set of nodes corresponding to the resource type of the currently considered resource descriptor to be added to the next set of nodes for processing by the currently disclosed argument-binding process. When a node is selected for the next set of notes for processing, the variable another is set to TRUE, so that another iteration of the second step of the currently disclosed argument-biting process will be executed.

FIG. 31J provides a control-flow diagram for a routine “resolve references,” called in step 3131 of FIG. 31G. In step 3182, the routine “resolve references” receives references to the various data structures as well as to indexes dex and j that specify a particular resource-descriptor pointer stored in the ST data structure. In step 3138, local variable r is set to reference a resource descriptor of a resource type corresponding to currently considered nodes in the dependency-graph component. In the for-loop of steps 3184-3189, each field value or attribute value in the resource descriptor is considered. In step 3185, the routine “resolve references” sets a value pointer vp to the value returned by the member function find of the reference map RM for the currently considered value. When vp is null, as determined in step 3186, the value is not contained in the reference map. Otherwise, in step 3187, the routine “resolve references” replaces the value in the resource descriptor with an argument binding using the value pointer vp obtained from the reference map RM.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters.

What is claimed is:

1. An automated infrastructure-as-code cloud-infrastructure manager comprising:
one or more computer systems, each containing one or more processors, one or more memories, and one or more data-storage devices; and
processor instructions, stored in one or more of the one or more memories that, when executed by one or more of the one or more processors, control the one or more computer systems to implement the automated infrastructure-as-code cloud-infrastructure manager, the infrastructure-as-code cloud-infrastructure-manager including
a management interface that receives cloud-infrastructure-management commands and requests, including
idempotent state commands that deploy and configure cloud infrastructure,
describe commands that return deployment and configuration information about already deployed and configured cloud infrastructure, and
onboard commands that generate a parameterized cloud template from already deployed and configured cloud infrastructure that is subsequently used to transfer management of the already deployed and configured cloud infrastructure to the cloud-infrastructure-manager and to deploy and configure new cloud infrastructure, the parameterized cloud template including argument bindings that reference resource IDs generated using argument-binding information that includes a dependency graph, and
an execution engine that executes the received cloud-infrastructure-management commands and requests.

2. The automated infrastructure-as-code cloud-infrastructure manager of claim 1 wherein the onboard command returns a parameterized cloud template comprising:
one or more data files containing resource specifications;
a resource_ids file; and
a parameters file.

3. The automated infrastructure-as-code cloud-infrastructure manager of claim 2 wherein the parameterized cloud template is used to transition the already deployed and configured cloud infrastructure to management by the automated infrastructure-as-code cloud-infrastructure manager by:
replacing resource function calls within the data files of the parameterized cloud template with corresponding resource ids extracted from the resource-id file;
replacing function calls within the data files of the parameterized cloud template with corresponding parameter values extracted from the parameters file;
storing the data files of the parameterized cloud template as a cloud template; and
using the cloud template for execution of automated infrastructure-as-code cloud-infrastructure manager commands.

4. The automated infrastructure-as-code cloud-infrastructure manager of claim 1 wherein the argument bindings that reference resource IDs generated using argument-binding information that includes a dependency graph are generated by:
receiving argument-binding information that includes the dependency graph, a set of parameter values, and a set of excluded attributes along with a set of resource descriptors; and
for each component of the dependency graph,
generating argument bindings to replace field and attribute values in one or more of the resource descriptors using the dependency-graph component, the set of parameter values, and the set of excluded attributes.

5. The automated infrastructure-as-code cloud-infrastructure manager of claim 4 wherein the resource descriptors are included in one of:
one or more specification-and-configuration data files; and
an in-memory data structure.

6. The automated infrastructure-as-code cloud-infrastructure manager of claim 4 wherein the resource descriptors each includes a reference ID, an indication of a resource type, and one or more attribute/attribute value pairs.

7. The automated infrastructure-as-code cloud-infrastructure manager of claim 6 wherein a dependency-graph component comprises:
multiple nodes, each representing a resource type; and
multiple directed edges, each edge connecting two nodes and representing a dependency of the resource type represented by one of the two nodes on the resource type represented by the other of the two nodes, wherein a first resource type depends on a second resource type when resource descriptors of the first resource type include one or more field and/or attribute values that are resource IDs that identify, and are included in, resource descriptors of the second resource type.

8. The automated infrastructure-as-code cloud-infrastructure manager of claim 7 wherein generating argument bindings to replace field and attribute values in one or more of the resource descriptors using the dependency-graph component, the set of parameters, and the set of excluded attributes further comprises:
grouping the resource descriptors by resource type;
identifying root nodes in the dependency-graph component;
selecting the root nodes as the currently considered nodes in the dependency-graph component;
placing the resource identifiers in the resource descriptors of the resource types represented by the root nodes into a reference map that includes resource-ID/value-pointer pairs;
marking the root nodes as processed; and
iteratively processing additional sets of nodes selected from the dependency-graph component until the nodes of the dependency-graph component have been processed.

9. The automated infrastructure-as-code cloud-infrastructure manager of claim 8 wherein iteratively processing additional sets of nodes selected from the dependency-graph component until the nodes of the dependency-graph component have been processed further comprises:
iteratively
selecting a next set of nodes based on the currently considered nodes,
considering the next set of nodes to be the currently considered nodes,
for each replaceable field value and attribute value of each resource descriptor of a resource type represented by the currently considered nodes that contains a resource ID that occurs in the first field of a resource-ID/value-pointer pair in the reference map, replacing the field or attribute value with an argument binding using the value pointer in the resource-ID/value-pointer pair,
clearing the reference map, and
placing the resource identifiers in the resource descriptors of the resource types represented by currently considered nodes into the reference map along with value pointers to the resource identifiers.

10. The automated infrastructure-as-code cloud-infrastructure manager of claim 9 wherein selecting a next set of nodes based on the currently considered nodes further includes selecting nodes, each connected to a node of the currently considered nodes by an edge, that depend on the currently considered nodes.

11. The automated infrastructure-as-code cloud-infrastructure manager of claim 9
wherein a replaceable field value has a value that is not included in the received set of parameter values; and
wherein a replaceable attribute value has a value that is not included in the received set of parameter values and the attribute associated with the attribute value is not included in the received set of excluded attributes.

12. A method that inserts argument bindings into reference resource IDs into a parameterized cloud template generated by an automated infrastructure-as-code cloud-infrastructure manager that includes one or more computer systems, each containing one or more processors, one or more memories, and one or more data-storage devices, a management interface that receives cloud-infrastructure-management commands and requests, and an execution engine that executes the received cloud-infrastructure-management commands and requests, the method comprising:
receiving argument-binding information that includes a dependency graph, a set of parameter values, and a set of excluded attributes along with a set of resource descriptors; and
for each component of the dependency graph,
generating argument bindings to replace field and attribute values in one or more of the resource descriptors using the dependency-graph component, the set of parameter values, and the set of excluded attributes.

13. The method of claim 12 wherein the resource descriptors are included in one of:
one or more specification-and-configuration data files; and
an in-memory data structure.

14. The method of claim 13 wherein the resource descriptors each includes a reference ID, an indication of a resource type, and one or more attribute/attribute value pairs.

15. The method of claim 14 wherein a dependency-graph component comprises:
multiple nodes, each representing a resource type; and
multiple directed edges, each edge connecting two nodes and representing a dependency of the resource type represented by one of the two nodes on the resource type represented by the other of the two nodes, wherein a first resource type depends on a second resource type when resource descriptors of the first resource type include one or more field and/or attribute values that are resource IDs that identify, and are included in, resource descriptors of the second resource type.

16. The method of claim 15 wherein generating argument bindings to replace field and attribute values in one or more of the resource descriptors using the dependency-graph component, the set of parameters, and the set of excluded attributes further comprises:
grouping the resource descriptors by resource type;
identifying root nodes in the dependency-graph component;
selecting the root nodes as the currently considered nodes in the dependency-graph component;
placing the resource identifiers in the resource descriptors of the resource types represented by the root nodes into a reference map that includes resource-ID/value-pointer pairs;
marking the root nodes as processed; and
iteratively processing additional sets of nodes selected from the dependency-graph component until the nodes of the dependency-graph component have been processed.

17. The method of claim 16 wherein iteratively processing additional sets of nodes selected from the dependency-graph component until the nodes of the dependency-graph component have been processed further comprises:
iteratively
selecting a next set of nodes based on the currently considered nodes,
considering the next set of nodes to be the currently considered nodes,
for each replaceable field value and attribute value of each resource descriptor of a resource type represented by the currently considered nodes that contains a resource ID that occurs in the first field of a resource-ID/value-pointer pair in the reference map, replacing the field or attribute value with an argument binding using the value pointer in the resource-ID/value-pointer pair,
clearing the reference map, and
placing the resource identifiers in the resource descriptors of the resource types represented by currently considered nodes into the reference map along with value pointers to the resource identifiers.

18. The method of claim 17 wherein selecting a next set of nodes based on the currently considered nodes further includes selecting nodes, each connected to a node of the currently considered nodes by an edge, that depend on the currently considered nodes.

19. The method of claim 18
wherein a replaceable field value has a value that is not included in the received set of parameter values; and
wherein a replaceable attribute value has a value that is not included in the received set of parameter values and the attribute associated with the attribute value is not included in the received set of excluded attributes.

20. A physical data-storage device encoded with processor instructions that, when executed by one or more processors within one or more computer systems, each containing one or more processors, one or more memories, and one or more data-storage devices, control the one or more computer systems to implement an automated cloud-infrastructure manager, the automated cloud-infrastructure manager comprising:
a management interface that receives cloud-infrastructure-management commands and requests, including
idempotent state commands that deploy and configure cloud infrastructure,
describe commands that return deployment and configuration information about already deployed and configured cloud infrastructure, and
onboard commands that generate a parameterized cloud template from already deployed and configured cloud infrastructure that is subsequently used to transfer management of the already deployed and configured cloud infrastructure to the cloud-infrastructure-manager and to deploy and configure new cloud infrastructure, the parameterized cloud template including argument bindings that reference resource IDs generated using argument-binding information that includes a dependency graph; and
an execution engine that executes the received cloud-infrastructure-management commands and requests.
